(19) United States
(12) Patent Application Publication
(10) Pub. No.: US 2024/0396048 A1
(43) Pub. Date: Nov. 28, 2024

(54) SECONDARY BATTERY

(71) Applicant: SEMICONDUCTOR ENERGY LABORATORY CO., LTD., Atsugi-shi, Kanagawa-ken (JP)

(72) Inventors: Yusuke YOSHITANI, Isehara, Kanagawa (JP); Noriko MIYAIRI, Hadano, Kanagawa (JP); Mayumi MIKAMI, Atsugi, Kanagawa (JP); Kazuki TANEMURA, Isehara, Kanagawa (JP); Kanta ABE, Atsugi, Kanagawa (JP); Tatsuyoshi TAKAHASHI, Atsugi, Kanagawa (JP); Kenta NAKANISHI, Atsugi, Kanagawa (JP); Shunpei YAMAZAKI, Setagaya, Tokyo (JP)

(21) Appl. No.: 18/697,576

(22) PCT Filed: Sep. 26, 2022
(86) PCT No.: PCT/IB2022/059081

§ 371 Date: Apr. 1, 2024

(30) Foreign Application Priority Data
Oct. 8, 2021 (JP) 2021-166299

(51) Int. Cl. H01M 4/62; H01M 4/02; H01M 4/36; H01M 4/525; H01M 4/58

(52) U.S. Cl. CPC H01M 4/628; H01M 4/364; H01M 4/366; H01M 4/525; H01M 4/5825; H01M 2004/028

(57) ABSTRACT

A secondary battery includes a positive electrode active material layer including a primary particle containing lithium, nickel, cobalt, and manganese and a secondary particle formed by aggregation of the primary particles, and calcium is contained between adjacent primary particles of the secondary particle. With such a structure, calcium inhibits oxygen release from the primary particle in charging and discharging, whereby the reliability of the secondary battery is improved.

### TECHNICAL FIELD

One embodiment of the present invention relates to a positive electrode active material, a secondary battery, and a manufacturing method thereof. One embodiment of the present invention relates to a portable information terminal and a vehicle each including a secondary battery.

One embodiment of the present invention relates to an object or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that in this specification, a semiconductor device refers to any device that can function by utilizing semiconductor characteristics, and an electro-optical device, a semiconductor circuit, and an electronic device are all semiconductor devices.

Note that in this specification, a power storage device refers to all elements and devices each having a function of storing power. For example, a power storage device (also referred to as a secondary battery) of a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of portable information terminals typified by mobile phones, smartphones, or laptop computers, portable music players, digital cameras, medical equipment, next-generation clean energy vehicles typified by hybrid electric vehicles (HVs), electric vehicles (EVs), or plug-in hybrid electric vehicles (PHVs), and the semiconductor industry, and the lithium-ion secondary batteries are essential for today's information society as rechargeable energy supply sources.

Patent Document 1 discloses a positive electrode active material for a lithium-ion secondary battery with high capacity and excellent charge and discharge cycle performance.

### REFERENCE

### Patent Document

[Patent Document 1] PCT International Publication No. 2020/099978

### SUMMARY OF THE INVENTION

### Problems to be Solved by the Invention

An object of one embodiment of the present invention is to provide a positive electrode active material with high charge and discharge capacity. Another object is to provide a positive electrode active material with high charge and discharge voltage. Another object is to provide a positive electrode active material that hardly deteriorates. Another object is to provide a novel positive electrode active material. Another object is to provide a secondary battery with high charge and discharge capacity. Another object is to provide a secondary battery with high charge and discharge voltage. Another object is to provide a highly safe or highly reliable secondary battery. Another object is to provide a secondary battery that hardly deteriorates. Another object is to provide a long-life secondary battery. Another object is to provide a novel secondary battery.

Another object of one embodiment of the present invention is to provide a novel material, a novel active material, a novel power storage device, or a manufacturing method thereof.

Note that the description of these objects does not preclude the existence of other objects. Note that one embodiment of the present invention does not have to achieve all the objects. Other objects can be derived from the description of the specification, the drawings, and the claims.

### Means for Solving the Problems

For a lithium-ion secondary battery, what is called NCM represented by LiNi_{X}Co_{Y}Mn_{Z}O₂ (X+Y+Z=1) is generally used. A material containing transition metals at approximately the same ratios, like Ni:Co:Mn=1:1:1, contains a large amount of cobalt, which is a noble metal, and thus is likely to result in a high cost. There is an attempt to increase the capacity of batteries by reducing the use amount of cobalt and increasing the use amount of nickel.

NCM with a large use amount of nickel has a problem in that oxygen is easily released and deterioration is likely to occur. Furthermore, there is also a problem in that a phenomenon called cation mixing in which a transition metal typified by nickel and manganese enters a site for lithium ions to be inserted or extracted in charging and discharging is likely to occur.

In order to achieve the above-described objects, the present inventors have devised the following structure. The structure is a secondary battery including a positive electrode active material layer including a primary particle containing lithium, nickel, cobalt, and manganese and a secondary particle formed by aggregation of the primary particles, and calcium is contained between adjacent primary particles of the secondary particle. The adjacent primary particles, specifically, include coating film portions of the primary particles. With such a structure, calcium inhibits oxygen release from the primary particle in charging and discharging, whereby the reliability of the secondary battery is improved.

In this specification, a primary particle or a secondary particle that inserts or extracts lithium ions is referred to as a positive electrode active material, and a coating film of the primary particle is referred to as a positive electrode active material regardless of the presence or absence of the function as a positive electrode active material. Although a movement of lithium ions in charging and discharging may occur in the coating film of the primary particle, the coating film has a function different from that of the positive electrode active material because there is no change in an electrode potential caused by the insertion and extraction of the lithium ions.

Calcium is added as a calcium compound, specifically calcium oxide and typically calcium carbonate and subjected to heat treatment so that calcium cannot be contained in a primary particle. Calcium whose ion radius is relatively large is less likely to enter the primary particle. Another structure disclosed in this specification is a secondary battery including a positive electrode active material layer including a primary particle containing lithium, nickel, cobalt, and manganese and a secondary particle formed by aggregation of the primary particles: at least a portion of a surface of the primary particle includes a coating film containing lithium carbonate; and a concentration of calcium contained in the primary particle is lower than a concentration of calcium contained in the coating film. It is probable that calcium is present as the coating film or as a lump on the outer side of the primary particle and located between adjacent primary particles. Furthermore, calcium is probably present in an inner portion or on the outer side of the secondary particle formed by aggregation of the primary particles as the coating film or as the lump.

The method for manufacturing the secondary particle disclosed in this specification is a manufacturing method of a positive electrode active material, including: supplying an aqueous solution containing a water-soluble nickel salt, a water-soluble cobalt salt, and a water-soluble manganese salt, and an alkaline solution to a reaction vessel and mixing the aqueous solution and the alkaline solution in the reaction vessel to precipitate a compound containing at least nickel, cobalt, and manganese; heating a first mixture of the compound containing at least nickel, cobalt, and manganese and a lithium compound at a first heating temperature and crushing or grinding the first mixture; heating the first mixture at a second heating temperature; and heating a second mixture obtained by mixing the first mixture and a calcium compound at a third heating temperature. Note that the third heating temperature is higher than 662° C. and lower than or equal to 1050° C.

The upper limit of the third heating temperature is 1050° C. and, without particular limitation, is preferably lower than the reduction decomposition temperature of a mixture to be the primary particle; when the content of cobalt is decreased and the content of nickel is increased to reduce the material cost, the reduction decomposition temperature tends to lower, and thus the upper limit of the third heating temperature is preferably changed in accordance with the reduction decomposition temperature.

One embodiment of the present invention is not limited to the above method and is a manufacturing method of a positive electrode active material, including: supplying a water-soluble nickel salt, a water-soluble cobalt salt, and a water-soluble manganese salt, and an alkaline solution to a reaction vessel and mixing the salts and the alkaline solution in the reaction vessel to precipitate a compound containing at least nickel, cobalt, and manganese; heating a first mixture of the compound containing at least nickel, cobalt, and manganese, a lithium compound, and a calcium compound at a first heating temperature and crushing or grinding the first mixture; and heating the first mixture at a second heating temperature. Note that each of the first heating temperature and the second heating temperature is higher than 662° C. and lower than or equal to 1050° C.

A coating film to be formed after heat treatment of the first heating or the second heating may have a thickness greater than or equal to 1 nm and less than or equal to 1 μm, for example.

Note that since the heat treatment temperature is lower than or equal to 1050° C. in the above method, no calcium enters the primary particle but a coating film containing calcium is formed on the outer side of the primary particle. Any one or more of lithium carbonate, calcium carbonate (CaCO_{X}(3≥X)), and calcia is contained as a coating film component. Thus, calcium does not greatly influence a function related to charging and discharging in the positive electrode active material. Calcium is located between the primary particles to inhibit oxygen release from the primary particle or the secondary particle. Specifically, calcium is contained in the coating film of the primary particle. Furthermore, a structure in which a second coating film is formed on the surface or part of the surface of the secondary particle and the second coating film contains calcium may be employed.

It is preferable that the composition of the primary particle that constitutes the secondary particle be set as appropriate with the adjustment of a material in fabrication by the practitioner and for cost reduction, the amount of nickel contained in the secondary particle be larger than that of cobalt or manganese and the use amount of cobalt be reduced. The composition of the primary particle is within the range represented by Li_{W}Ni_{X}Co_{Y}Mn_{Z}O₂ (note that 0.89<W<1.07, X+Y+Z=1 and X>0, Y>0, Z>0), preferably 0.7<X<0.95, 0.05≤Y<0.2.0.05≤Z<0.2). A concentration of calcium contained in the secondary particle is higher than or equal to 0.1 atm % and lower than or equal to 5 atm %. Here, the concentration of calcium is a value based on the adding amount at the time of manufacturing a secondary particle, that is, the concentration of calcium with respect to a nickel compound (containing cobalt and manganese) serving as a coprecipitation precursor; so the calcium concentration does not agree with the actually measured concentration in some cases.

The composition of the primary particle is not limited to Li_{W}Ni_{X}Co_{Y}Mn_{Z}O₂, and aluminum or magnesium may be added. Unlike calcium, in the case where aluminum is added, nickel is more likely to be replaced by aluminum; thus, aluminum is contained in the primary particle. In the case where aluminum is added, adjustments may be made to be Li_{W}Ni_{X}Co_{Y}Mn_{Z}Al_{A}O₂ (note that X+Y+Z+A=1, 0.89<W<1.07, and X>0, Y>0, Z>0). In the case where aluminum is added, the reliability of the secondary battery is improved. When aluminum is added by a coprecipitation method, an aqueous solution of aluminum sulfate, aluminum chloride, aluminum nitrate, or a hydrate thereof can be used. When magnesium is added by a coprecipitation method, an aqueous solution of magnesium sulfate, magnesium chloride, magnesium nitrate, or a hydrate thereof can be used.

The pH in the reaction vessel used for the coprecipitation method is preferably greater than or equal to 9.0 and less than or equal to 12.0, further preferably greater than or equal to 10.5 and less than or equal to 11.5.

When the aqueous solution and the alkaline solution are mixed to precipitate a compound at least containing nickel, cobalt, and manganese, a chelating agent is added. Examples of the chelating agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. The chelating agent is dissolved in pure water, which is used as a chelate aqueous solution. The chelating agent serves as a complexing agent to form a chelate compound, and is more preferable than a general complexing agent. Needless to say, a complexing agent may be used instead of the chelating agent, and ammonia water can be used as the complexing agent.

The use of the chelate aqueous solution is preferable also because the chelate aqueous solution suppresses generation of unnecessary crystal nuclei and promotes growth. Since generation of unnecessary crystal nuclei is suppressed to inhibit generation of fine particles, a composite oxide with good particle size distribution can be obtained. Furthermore, the use of the chelate aqueous solution can slow an acid-base reaction, so that the reaction gradually progresses to form a nearly spherical secondary particle. In the case where a glycine aqueous solution is used as the chelate aqueous solution, the glycine concentration in the glycine aqueous solution is preferably 0.075 mol/L to 0.4 mol/L inclusive, in the aqueous solution.

The positive electrode active material obtained by the above-described method includes crystal having a hexagonal crystal layered structure. The crystal is not limited to a single crystal (also referred to as a crystallite). In the case where the crystal is polycrystalline, some crystallites gather to form a primary particle. The primary particle indicates a particle recognized as a single grain with a smooth surface when observed with a SEM. The secondary particle indicates a group of aggregated primary particles. In the SEM observation or the like, boundaries or color differences are observed between primary particles which are different in crystallinity, crystal orientation, composition, or the like. Thus, the different primary particles can be visually recognized as different regions in many cases. For the aggregation of the primary particles, there is no particular limitation on the bonding force between the plurality of primary particles. The bonding force may be any of covalent bonding, ionic bonding, a hydrophobic interaction, the Van der Waals force, and other molecular interactions, or a plurality of bonding forces may work together.

When the coprecipitation method is employed, the secondary particle is formed in some cases. The size of the secondary particle is 5 μm to 30 μm inclusive, and the size of the primary particle is 50 nm to 500 nm inclusive. The size of the secondary particle refers to the average particle diameter, specifically a value of D50, measured by a particle diameter distribution analyzer using a laser diffraction and scattering method.

The secondary battery including a positive electrode using the secondary particle is also one of the structures disclosed in this specification. The secondary battery includes the positive electrode including the secondary particle and a negative electrode including a negative electrode active material. In addition, a separator is included between the positive electrode and the negative electrode. The separator is used for preventing short circuit; thus, a secondary battery with high safety or high reliability can be provided.

### Effect of the Invention

Calcium contained in a secondary particle inhibits oxygen release in charging and discharging, so that the reliability of a secondary battery can be improved. When oxygen is released from a primary particle by charging and discharging, a crystal structure in the primary particle, specifically a layered structure, is broken and may lead to the deterioration of the secondary battery. When oxygen is released and a layered structure of the surface of a crystal is broken, the surface of the crystal changes irreversibly into a spinel structure or a rock-salt structure, which becomes one of the causes that hinders passage of lithium ions in charging and discharging. Furthermore, calcium oxide has an effect of inhibiting deterioration of the secondary battery by capturing and fixing water and carbon dioxide generated in the decomposition of an electrolyte solution.

Thus, when calcium is contained in the secondary particle, the layered structure of the primary particle can be maintained and the capacity retention rate can be kept high.

Furthermore, when calcium is contained, the number of spaces that are dotted in an inner portion of the secondary particle can be reduced.

Moreover, even when calcium is contained, an initial discharge capacity exceeding 200 mAh/g can be achieved in a half cell.

Note that the description of these effects does not preclude the existence of other effects. Note that one embodiment of the present invention does not need to have all the effects. Other effects will be apparent from the description of the specification, the drawings, and the claims, and other effects can be derived from the description of the specification, the drawings, and the claims.

### BRIEF DESCRIPTION OF THE DRAWINGS

FIG. 1A is a SIM image of a cross section of a secondary particle illustrating one embodiment of the present invention, and FIG. 1B is a diagram showing the results of plotting a mass spectrum of calcium corresponding to FIG. 1A.

FIG. 2A is an enlarged view of part of FIG. 1A, and FIG. 2B is a diagram showing the results of plotting a mass spectrum of calcium in FIG. 1B.

FIG. 3A and FIG. 3B are graphs showing XPS analysis results.

FIG. 4 is a diagram showing an example of a manufacturing flow chart illustrating one embodiment of the present invention.

FIG. 5 is a graph showing a phase diagram of lithium carbonate and calcium carbonate.

FIG. 6A is a cross-sectional view illustrating an example of a calculation model, and FIG. 6B is a graph showing calculation results.

FIG. 7 is a graph showing calculation results.

FIG. 8 is a cross-sectional view illustrating a reaction vessel used for one embodiment of the present invention.

FIG. 9A is an exploded perspective view of a coin-type secondary battery, FIG. 9B is a perspective view of the coin-type secondary battery, and FIG. 9C is a cross-sectional perspective view thereof.

FIG. 10A illustrates an example of a cylindrical secondary battery. FIG. 10B illustrates the example of the cylindrical secondary battery. FIG. 10C illustrates an example of a plurality of cylindrical secondary batteries. FIG. 10D illustrates an example of a power storage system including a plurality of cylindrical secondary batteries.

FIG. 11A and FIG. 11B illustrate examples of a secondary battery, and FIG. 11C is a diagram illustrating the internal state of a secondary battery.

FIG. 12A to FIG. 12C are diagrams illustrating an example of a secondary battery.

FIG. 13A and FIG. 13B are external views of a secondary battery.

FIG. 14A to FIG. 14C are diagrams illustrating a manufacturing method of a secondary battery.

FIG. 15A to FIG. 15C are diagrams illustrating structure examples of a battery pack.

FIG. 16A and FIG. 16B are diagrams illustrating examples of a secondary battery.

FIG. 17A to FIG. 17C are diagrams illustrating an example of a secondary battery.

FIG. 18A and FIG. 18B are diagrams illustrating examples of a secondary battery.

FIG. 19A is a perspective view of a battery pack of one embodiment of the present invention, FIG. 19B is a block diagram of the battery pack, and FIG. 19C is a block diagram of a vehicle having a motor.

FIG. 20A to FIG. 20D are diagrams illustrating examples of transport vehicles.

FIG. 21A and FIG. 21B are diagrams illustrating power storage devices of one embodiment of the present invention.

FIG. 22A is a diagram illustrating an electric bicycle, FIG. 22B is a diagram illustrating a secondary battery of an electric bicycle, and FIG. 22C is a diagram illustrating an electric motorcycle.

FIG. 23A to FIG. 23D are diagrams illustrating examples of electronic devices.

FIG. 24A and FIG. 24B are external views illustrating a charging station.

FIG. 25 is a diagram showing a manufacturing process flow chart illustrating one embodiment of the present invention.

FIG. 26A is a graph showing a length of the a-axis of each sample, and FIG. 26B is a graph showing a length of the c-axis of each sample.

FIG. 27A is a graph showing charge and discharge cycle performance of a secondary battery at 45° C. with the vertical axis representing discharge capacity, and FIG. 27B is a graph showing charge and discharge cycle performance thereof with the vertical axis representing discharge capacity retention rate.

FIG. 28A is a graph showing charge and discharge cycle performance of the secondary battery at 45° C. with the vertical axis representing discharge capacity, and FIG. 28B is a graph showing charge and discharge cycle performance thereof with the vertical axis representing discharge capacity retention rate.

FIG. 29A is a graph showing charge and discharge cycle performance of the secondary battery at 45° C. with the vertical axis representing discharge capacity, and FIG. 29B is a graph showing charge and discharge cycle performance thereof with the vertical axis representing discharge capacity retention rate.

FIG. 30 is a SEM observation image of a cross section of an electrode of a sample after 100 cycles of charge and discharge tests (4.5 V, 45° C.).

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

In this embodiment, a secondary particle obtained through a process in which a coprecipitation precursor where Co, Ni, and Mn are present in one particle is formed by a coprecipitation method, heating is performed twice after a Li salt is mixed with the coprecipitation precursor, and then a calcium compound is added will be described.

Analysis results of the secondary particle disclosed in this embodiment are shown below.

The secondary particle disclosed in this embodiment has a feature of containing calcium between adjacent primary particles among a plurality of primary particles constituting the secondary particle.

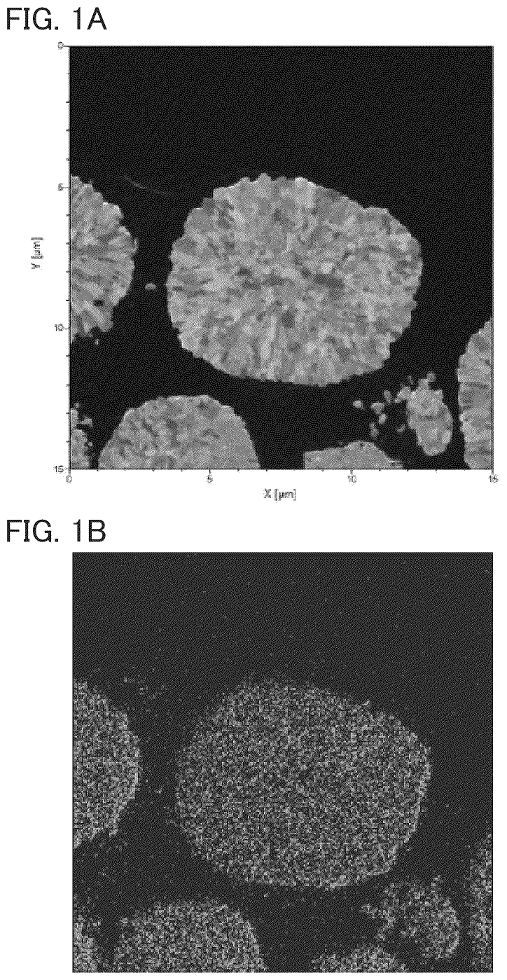

FIG. 1A is a SIM (Scanning Ion Microscope) image corresponding to an area of 15 μm×15 μm of the secondary particle obtained by using an FIB (Focused Ion Beam) apparatus. A state in which the primary particles are aggregated to constitute the secondary particle can be observed.

FIG. 1B is a diagram relating to portions where calcium is present in the area of 15 μm×15 μm in which the mass spectra of calcium in corresponding portions are plotted in an FIB-MS (Focused Ion Beam Mass Spectrometry) analysis. As analysis apparatuses in FIG. 1B, Crossbeam 550 produced by Carl Zeiss is used as the SEM and ToF-SIMS-Detector produced by Carl Zeiss is used as the TOF-MS. For the observation conditions, the SEM image observation is performed at 2 kV and the sample inclination angle is 0°, and for the analysis conditions, the acceleration voltage is 20 kV, the primary ion species is Ga, and the measurement mode is positive ions. FIG. 1B corresponds to FIG. 1A and shows that calcium is dotted.

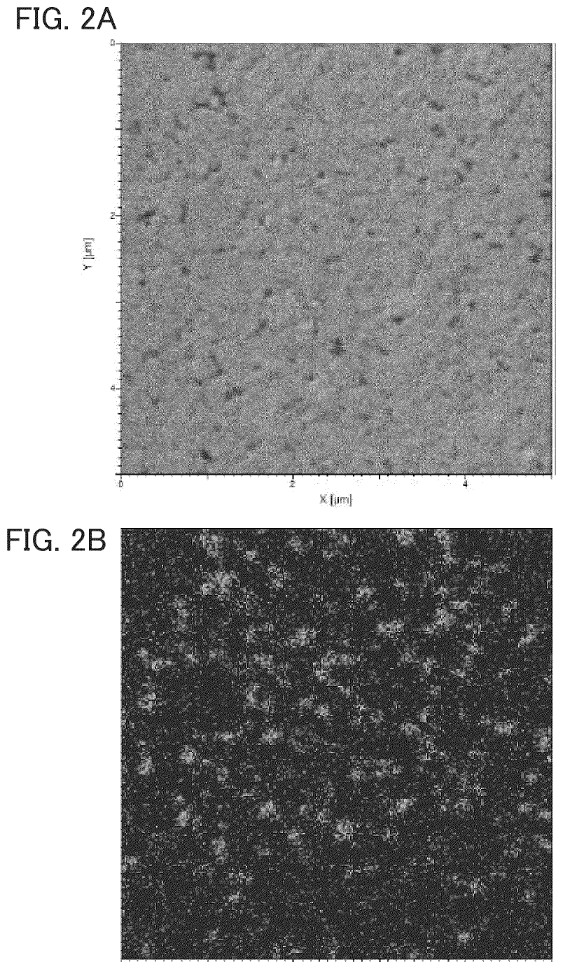

FIG. 2A is a cross-sectional SIM image corresponding to an area of 5 μm×5 μm of the secondary particle.

FIG. 2B is a diagram relating to portions where calcium is present in an area of 5 μm×5 μm subjected to FIB-MS analysis. It can be observed that calcium is present on the outer side of the primary particle, not in the primary particle. When a coating film is formed on the surface of the primary particle, the coating film contains calcium. Although no presence of calcium is observed in the primary particle in the results of the FIB-MS analysis shown in FIG. 2B, calcium may be present in the primary particle. In that case, the calcium concentration contained in the primary particle is preferably lower than the calcium concentration contained in the coating film formed on the surface of the primary particle. In the case where a larger amount of calcium is contained in an inner portion of the primary particle than in the coating film, a defect may occur in the crystal structure in the primary particle or the discharge capacity may be reduced.

Table 1 shows XPS analysis results of the surface of a secondary particle. In Table 1, the quantification results obtained by XPS of the secondary particle with no calcium added, the secondary particle with calcium added at 1 atm %, and the secondary particle with calcium added at 5 atm % are shown. Note that “-” in Table 1 represents a value that is lower than or equal to the detection lower limit.

TABLE 1

| Ca added | Li | Ni | Co | Mn | O | Ca | C | S |
|---|---|---|---|---|---|---|---|---|
| None | 26.3 | 2.8 | 0.2 | 0.3 | 50.9 | — | 18.4 | 1.1 |
| 1 at % | 25.3 | 0.7 | — | 0.1 | 52.0 | 0.7 | 20.1 | 1.1 |
| 5 at % | 23.0 | 0.6 | — | 0.1 | 52.6 | 1.5 | 21.9 | 0.2 |

In an inorganic oxide, a region that is approximately 2 nm to 8 nm (typically, less than or equal to 5 nm) in depth from the surface can be analyzed by X-ray photoelectron spectroscopy (XPS) using monochromated aluminum Kα radiation as an X-ray source; thus, the concentrations of elements in approximately half the depth of the surface can be quantitatively analyzed. The bonding states of the elements can be analyzed by narrow scanning. Note that the quantitative accuracy of XPS is approximately ±1 atm % in many cases, and the detection lower limit depends on the element but is approximately 1 atm %.

In the XPS analysis, monochromatic aluminum Kα radiation can be used as an X-ray source, for example. An extraction angle is, for example, 45°. For example, the measurement can be performed using the following apparatus and conditions.
Measurement apparatus: Quantera II produced by PHI, Inc.
X-ray source: monochromatic Al Kα (1486.6 eV)
Detection area: 100 μmϕ
Detection depth: approximately 4 to 5 nm (extraction angle 45°)
Measurement spectrum: wide scanning, narrow scanning of each detected element

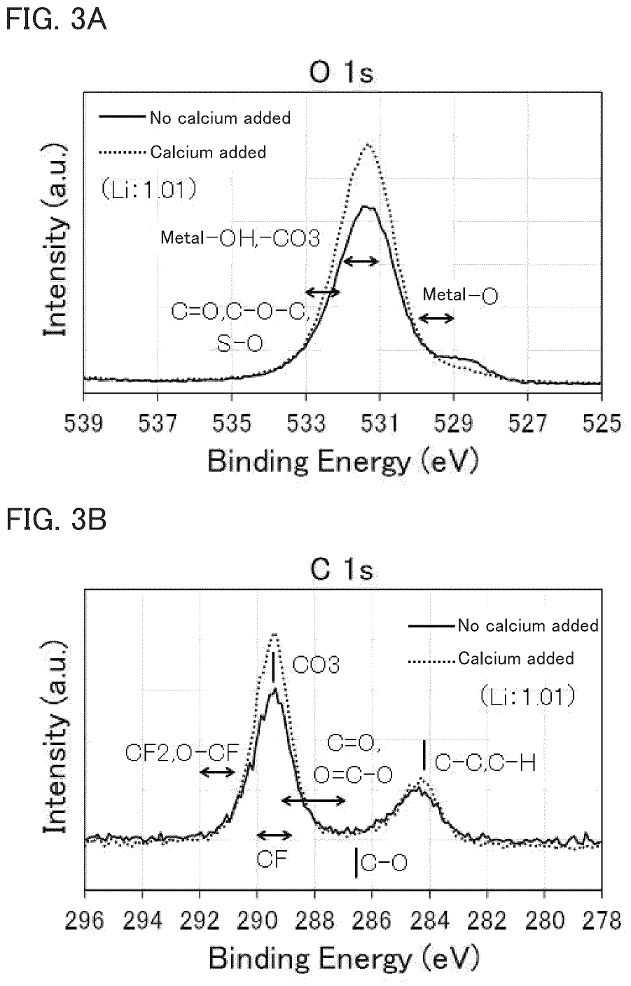

FIG. 3A and FIG. 3B show XPS analysis results different from those in Table 1 above. In FIG. 3A, the vertical axis represents intensity (Intensity) and the horizontal axis represents binding energy (Binding Energy). FIG. 3A shows XPS analysis of an O1s spectrum and FIG. 3B shows an XPS analysis of a C1s spectrum. FIG. 3A and FIG. 3B each show two kinds of samples: a secondary particle with no calcium added and a secondary particle with calcium added at 1 atm %.

As shown in the XPS analysis results of the surface of the above secondary particle, nickel, cobalt, and manganese, which are main constituent elements of NCM, are hardly detected on the surface of the particle and instead, lithium, carbon, and oxygen are detected as main components. This shows that a coating film different from that of NCM is probably formed for at least several nanometers on the surface of the secondary particle. The bonding state of carbon and oxygen shows that a coating film of lithium oxide or lithium carbonate may be present on the surface of the secondary particle with no calcium added. Calcium is detected in the sample with calcium added at 1 atm %. The bonding state of calcium shows that calcium may be present as calcium oxide or calcium carbonate on the surface of the secondary particle. A peak corresponding to the bond of metal-OH or the bond of metal-CO₃ is observed in FIG. 3A, and a peak corresponding to CO₃ is observed in FIG. 3B; thus, lithium carbonate is present on the surface of the secondary particle with no calcium added and the secondary particle may include a coating film containing lithium carbonate. Also in the secondary particle with calcium added at 1 atm %, lithium carbonate is present on the surface and the secondary particle may include the coating film containing lithium carbonate.

When XRD (X-ray Diffraction) analysis of the secondary particle is performed, the results indicate that a peak of calcium oxide (CaO, also referred to as calcia) is detected in the sample with calcium added at 5 atm %.

According to these analysis results, the surface of the secondary particle disclosed in this embodiment probably includes a coating film containing lithium carbonate or calcium oxide.

The positive electrode active material disclosed in this specification is a positive electrode active material that can be represented by LiNi_{X}Co_{Y}Mn_{Z}O₂ (X>0, Y>0, Z>0) and is a secondary particle containing calcium between primary particles in which X, Y, and Z satisfy X:Y:Z=8:1:1 or a value in the vicinity thereof. Furthermore, at least part of the surface of the secondary particle includes a coating film, and the coating film contains calcium.

The manufacturing process of the secondary particle disclosed in this embodiment is a process in which a coprecipitation precursor where Co, Ni, and Mn are present in one particle is formed using a coprecipitation apparatus that performs a coprecipitation method, heating is performed after a Li salt is mixed with the coprecipitation precursor, then a calcium compound (calcium carbonate) is added, and then heating is further performed.

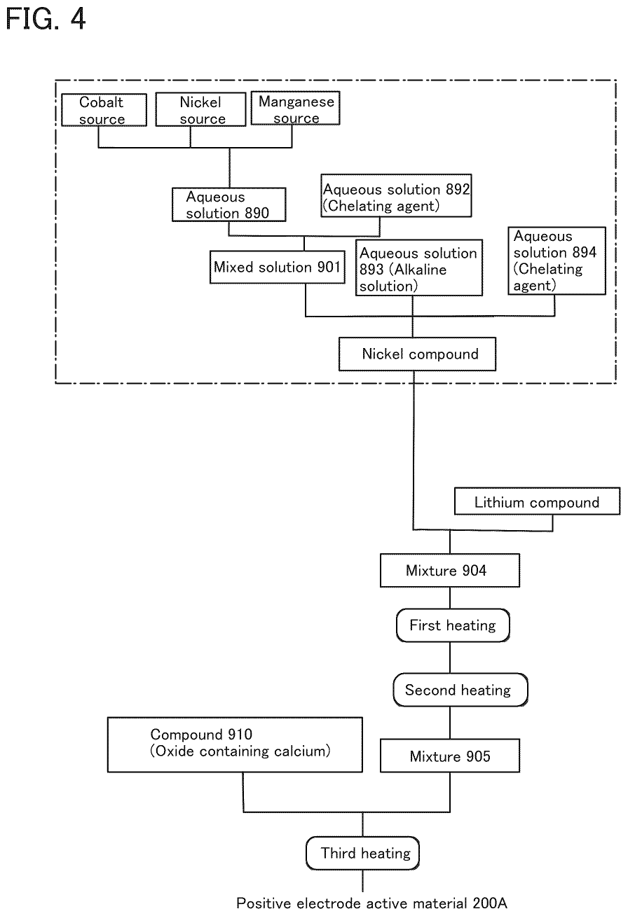

FIG. 4 shows a specific manufacturing flow chart. Note that the flow chart in FIG. 4 shows the order of components connected with lines. The flow chart does not show timing for the components not directly connected with lines. Note that the secondary particles in FIG. 1 and FIG. 2 are fabricated with reference to the flow chart shown in FIG. 4, and are analysis results of samples fabricated to have Li_{1.01}Ni_{X}Co_{Y}Mn_{Z}O₂ (X:Y:Z=8:1:1) with calcium added at 5 atm %

As shown in FIG. 4, a cobalt source, a nickel source, and a manganese source are prepared, an alkaline solution is prepared as an aqueous solution 893, and a chelating agent is prepared as aqueous solutions 892 and 894. The cobalt source, the nickel source, and the manganese source are mixed to form an aqueous solution 890. The aqueous solution 890 and the aqueous solution 892 are mixed to form a mixed solution 901. The mixed solution 901, the aqueous solution 893, and the aqueous solution 894 are reacted with one another, so that a compound containing at least nickel, cobalt, and manganese is formed. The reaction is referred to as a neutralization reaction, an acid-base reaction, or a coprecipitation reaction in some cases; the compound containing at least nickel, cobalt, and manganese (a nickel compound in FIG. 4) is referred to as a precursor (a coprecipitation precursor) of a nickel-cobalt-manganese compound in some cases. Note that a reaction caused by performing steps surrounded by the chain line in FIG. 4 can be referred to as the coprecipitation reaction.

### <Cobalt Aqueous Solution>

As examples of the cobalt aqueous solution, an aqueous solution containing cobalt sulfate (e.g., CoSO₄), cobalt chloride (e.g., CoCl₂), cobalt nitrate (e.g., Co(NO₃)₂), cobalt acetate (e.g., C₄H₆CoO₄), cobalt alkoxide, an organocobalt complex, or hydrate of any of these can be given. Alternatively, an organic acid of cobalt, such as cobalt acetate, or hydrate of the organic acid of cobalt may be used.

An aqueous solution obtained by dissolving these in pure water can be used, for example. The cobalt aqueous solution shows acidity, and thus can be referred to as an acid aqueous solution. The cobalt aqueous solution can be referred to as a cobalt source in a manufacturing process of a positive electrode active material.

### <Nickel Aqueous Solution>

As the nickel aqueous solution, an aqueous solution of nickel sulfate, nickel chloride, nickel nitrate, or hydrate of any of these can be used. Alternatively, an aqueous solution of an organic acid salt of nickel, such as nickel acetate, or hydrate of the organic acid salt of nickel can be used. Alternatively, an aqueous solution of nickel alkoxide or an organonickel complex can be used. In this specification and the like, the term “organic acid salt” denotes a compound of a metal and an organic acid such as an acetic acid, a citric acid, an oxalic acid, a formic acid, or a butyric acid.

### <Manganese Aqueous Solution>

As the manganese aqueous solution, an aqueous solution of manganese salt, such as manganese sulfate, manganese chloride, or manganese nitrate, or hydrate of any of these can be used. Alternatively, an aqueous solution of an organic acid salt of manganese, such as manganese acetate, or hydrate of the organic acid salt of manganese can be used. Alternatively, an aqueous solution of manganese alkoxide or an organomanganese complex can be used.

The above-described cobalt aqueous solution, nickel aqueous solution, and manganese aqueous solution may be prepared and mixed to form the aqueous solution 890; or nickel sulfate, cobalt sulfate, and manganese sulfate may be mixed and then mixed with water to form the aqueous solution 890, for example.

In this embodiment, nickel sulfate, cobalt sulfate, and manganese sulfate are weighed out to have desired amounts and mixed. The aqueous solution 890 in which nickel sulfate, cobalt sulfate, and manganese sulfate are mixed is mixed with the aqueous solution 892 to form the mixed solution 901. As the aqueous solutions 892 and 894, aqueous solutions serving as chelating agents are used; however, the aqueous solutions 892 and 894 are not particularly limited thereto and may be pure water.

### <Alkaline Solution>

As examples of the alkaline solution, an aqueous solution containing sodium hydroxide, potassium hydroxide, lithium hydroxide, or ammonia can be given. For example, an aqueous solution obtained by dissolving these in pure water can be used. An aqueous solution in which two or more kinds selected from sodium hydroxide, potassium hydroxide, and lithium hydroxide are dissolved in pure water may be used. The pure water is water with a resistivity of 1 MΩ·cm or higher, preferably water with a resistivity of 10 MΩ·cm or higher, further preferably water with a resistivity of 15 MΩ·cm or higher. Water with the above-described resistivity has high purity and an extremely small amount of impurities.

### <Reaction Condition>

In the case where a reaction is caused between the mixed solution 901 and the aqueous solution 893 by the coprecipitation method, the pH of the reaction system is set to greater than or equal to 9.0 and less than or equal to 12.0, and the pH is preferably set to greater than or equal to 10.5 and less than or equal to 11.5. For example, in the case where the aqueous solution 894 is put into a reaction vessel and the mixed solution 901 and the aqueous solution 893 are added into the reaction vessel, the pH of the aqueous solution in the reaction vessel is preferably kept in the above range. The same applies to the case where the aqueous solution 893 is put into the reaction vessel and the aqueous solution 894 and the mixed solution 901 are added. The same applies to the case where the mixed solution 901 is put into the reaction vessel and the aqueous solution 894 and the aqueous solution 893 are added. The liquid delivery speed of the aqueous solution 893, the aqueous solution 894, or the mixed solution 901 is preferably greater than or equal to 0.1 mL/min. and less than or equal to 0.8 mL/min., in which case the pH condition can be controlled easily. The reaction vessel contains at least a reaction container.

An aqueous solution in the reaction vessel is preferably stirred with a stirring means. The stirring means includes a stirrer or an agitator blade. Two to six agitator blades can be provided; for example, in the case where four agitator blades are provided, they may be placed in a cross shape seen from above. The number of rotations of the stirring means is preferably greater than or equal to 800 rpm and less than or equal to 1200 rpm.

The temperature in the reaction vessel is adjusted to be higher than or equal to 50° C. and lower than or equal to 90° C. The addition of the aqueous solution 893, the aqueous solution 894, or the mixed solution 901 is preferably started after the temperature becomes the above temperature.

The reaction vessel preferably has an inert atmosphere. For example, in the case of a nitrogen atmosphere, a nitrogen gas is preferably introduced at a flow rate of 0.5 L/min. or more and 2 L/min. or less.

In the reaction vessel, a reflux condenser is preferably placed. The nitrogen gas can be released from the reaction vessel and water can be returned to the reaction vessel with use of the reflux condenser.

After the above reactions, the compound containing at least nickel, cobalt, and manganese is precipitated in the reaction vessel. Filtration is performed to collect the compound containing at least nickel, cobalt, and manganese. After a reaction product precipitated in the reaction vessel is washed with pure water, an organic solvent (e.g., acetone) having a low boiling point is preferably added before the filtration is performed.

The compound containing at least nickel, cobalt, and manganese after the filtration is preferably further dried. For example, drying is performed under vacuum or under a reduced pressure at higher than or equal to 60° C. and lower than or equal to 120° C. for longer than or equal to 0.5 hours and shorter than or equal to 12 hours. In this manner, the compound containing at least nickel, cobalt, and manganese can be obtained.

The compound containing at least nickel, cobalt, and manganese obtained in the above reaction can be obtained as a secondary particle in which primary particles are aggregated. Note that in this specification, a primary particle refers to a particle (lump) of the smallest unit having no grain boundary when being observed, for example, at a magnification of 5000 times with a SEM (scanning electron microscope). In other words, the primary particle means a particle of the smallest unit surrounded by a grain boundary. A secondary particle refers to a particle in which the primary particles are aggregated, partially sharing the grain boundary (the circumference of the primary particle), and are not easily separated from each other (a particle independent of the other particles). That is, the secondary particle has a grain boundary in some cases.

In this embodiment, components are weighed and adjusted appropriately such that the atomic ratio of nickel, cobalt, and manganese is Ni:Co:Mn=8:1:1 or in the vicinity thereof in the compound containing at least nickel, cobalt, and manganese (the nickel compound in FIG. 4) which is obtained by the above coprecipitation method.

Next, a lithium compound is prepared.

### <Lithium Compound>

As examples of the lithium compound, lithium hydroxide (e.g., LiOH), lithium carbonate (e.g., Li₂CO₃ (with a melting point of 723° C.)), or lithium nitrate (e.g., LiNO₃) can be given. It is particularly preferable to use, among lithium compounds, a material having a low melting point typified by lithium hydroxide (with a melting point of 462° C.). Since a positive electrode active material having a high nickel proportion is likely to cause cation mixing as compared to lithium cobalt oxide, first heating needs to be performed at a low temperature. Therefore, it is preferable to use a material having a low melting point. The lithium concentration in a positive electrode active material 200A which will be described later may be adjusted appropriately in this stage. In this embodiment, the lithium concentration is adjusted as appropriate to be at a molar ratio of 1.01 with respect to the nickel compound (containing cobalt and manganese) serving as the coprecipitation precursor.

In this embodiment, the compound containing at least nickel, cobalt, and manganese, and the lithium compound are weighed out to have desired amounts and mixed to form a mixture 904. For the mixing, a mortar or a stirring mixer is used.

Next, the first heating is performed. An electric furnace, e.g., a rotary kiln furnace, can be used as a firing device for the first heating.

The first heating temperature is preferably higher than 400° C. and lower than or equal to 1050° C. The duration of the first heating is preferably longer than or equal to 1 hour and shorter than or equal to 20 hours.

Sequentially, the particles are ground or crushed in a mortar to have a uniform particle diameter, and then collected. Furthermore, classification may be performed using a sieve. In this embodiment, a crucible made of aluminum oxide (also referred to as alumina) with a purity of 99.9% is used. It is suitable to collect the heated materials after the materials are transferred from the crucible to a mortar in order to prevent impurities from entering the materials. The mortar is suitably made of a material which is less likely to release impurities. Specifically, it is suitable to use a mortar made of alumina with a purity of 90% or higher, preferably 99% or higher.

Next, second heating is performed. An electric furnace or a rotary kiln furnace can be used as a firing device for the second heating.

The second heating temperature is preferably higher than 400° C. and lower than or equal to 1050° C. The duration of the second heating is preferably longer than or equal to 1 hour and shorter than or equal to 20 hours. The second heating is preferably performed in an oxygen atmosphere, and in particular, preferably performed while oxygen is supplied. For example, the flow rate of oxygen is 10 L/min. per liter of inner capacity of the furnace. Specifically, the heating is preferably performed in a state where a container containing the mixture 904 is covered with a lid.

Sequentially, the particles are ground or crushed in a mortar to have a uniform particle diameter, and then collected. Furthermore, classification may be performed using a sieve.

Then, an obtained mixture 905 and a compound 910 are mixed. In this embodiment, a calcium compound is used as the compound 910.

### <Calcium Compound>

As examples of the compound 910, calcium oxide, calcium carbonate (with a melting point of 825° C.), and calcium hydroxide can be given. In this embodiment, calcium carbonate (CaCO₃) is used as the compound 910. As to the amount of the compound 910, it is desirable for the practitioner to appropriately add calcium that is weighed in the range of 0.5 atm % to 3 atm % inclusive with respect to the compound containing nickel, cobalt, and manganese such that the desired amount is contained, in consideration of the composition of the lithium compound and the composition of the compound containing at least nickel, cobalt, and manganese.

Then, third heating is performed. The third heating temperature is at least higher than the first heating temperature and is preferably higher than 662° C. and lower than or equal to 1050° C. The duration of the third heating is preferably shorter than that of the second heating and longer than or equal to 0.5 hour and shorter than or equal to 20 hours. The third heating is preferably performed in an oxygen atmosphere, and in particular, preferably performed while oxygen is supplied. For example, the flow rate of oxygen is 10 L/min. per liter of inner capacity of the furnace. Specifically, the heating is preferably performed in a state where a container containing the mixture 905 is covered with a lid.

Sequentially, the particles are ground or crushed in a mortar to have a uniform particle diameter, and then collected. Furthermore, classification may be performed using a sieve. With the crushing step, the grain size and/or the shape of the positive electrode active material 200A can be more uniform.

Through the above steps, the positive electrode active material 200A can be manufactured. The positive electrode active material 200A obtained through the above steps is NCM and calcium is contained in the coating film of the primary particle or the coating film of the secondary particle.

In order to reduce the number of steps in FIG. 4, a process in which heating is performed after a Li salt and the calcium compound (calcium carbonate) are mixed with the coprecipitation precursor may be employed. In that case, the third heating can be omitted.

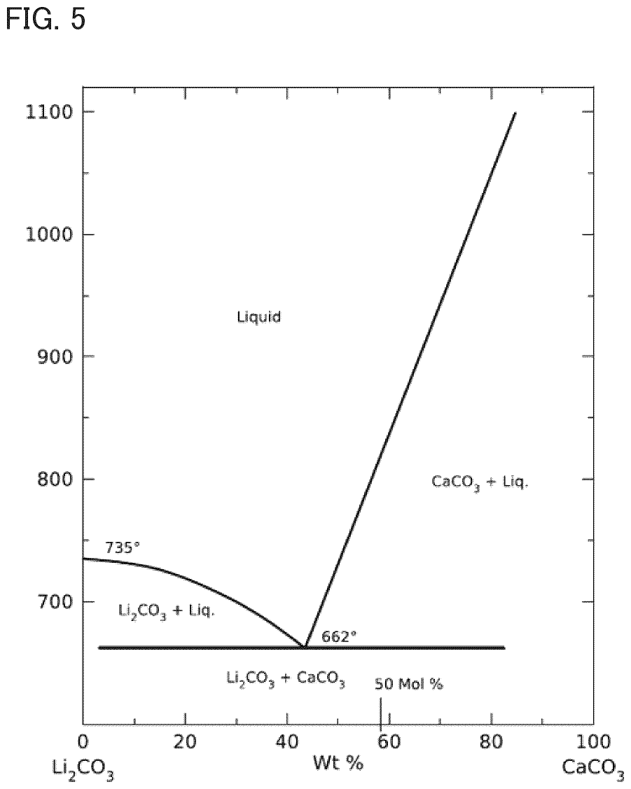

In both of the above-described manufacturing flow, heating after adding the calcium compound (calcium carbonate) is performed at a temperature at which the primary particle is not melted and at which calcium is not diffused in the primary particle. Note that FIG. 5 shows a phase diagram (an equilibrium state diagram) of calcium carbonate and lithium carbonate. On the basis of the phase diagram in FIG. 5, the lower limit temperature in the heating after adding the calcium compound (calcium carbonate) is set at a eutectic point of 662° C. When the heating after adding the calcium compound (calcium carbonate) is performed at a temperature higher than or equal to 662° C., calcium carbonate and lithium carbonate are melted and as a result, a melted substance of calcium carbonate and lithium carbonate is formed between the primary particles and calcium is diffused and dotted in the inner portion of the secondary particle. Thus, it is important that the heating after adding the calcium compound is performed at a temperature higher than or equal to 662° C. to obtain the secondary particle in this embodiment.

Here, the following simulation is performed to examine an influence on oxygen release in the particle surface in the case where the positive electrode active material includes a coating film containing lithium carbonate as a main component on an interface between primary particles or on the surface of a secondary particle.

In a structure where the coating film containing lithium carbonate is present on the surface of the primary particle, the difference in feasibility of oxygen release depending on whether calcium is added or not added is evaluated by comparing the oxygen release energy calculated by first-principles calculation using VASP (Vienna Ab initio Simulation Package).

An NCM particle forms a layered rock-salt structure similar to that of LiNiO₂ (hereinafter referred to as LNO), and lithium is diffused between NiO_{X} layers and is extracted and inserted from the particle, whereby charging and discharging are performed. Here, it is considered that when nickel is moved to a site where lithium is diffused from the NiO_{X} layer and the phase changes to a rock-salt structure of nickel oxide (NiO) through a spinel structure mainly formed of LiNi₂O₄, a portion that cannot contribute to charging and discharging is generated and deterioration of the NCM particle occurs. Oxygen is released when the phase change from an NiO₂ layer to the NiO occurs. In other words, the phase change is less likely to occur by inhibiting oxygen release from the NCM particle and deterioration is expected to be inhibited.

In view of this, whether adding calcium in the coating film has an effect of inhibiting oxygen release from the vicinity of the surface of the secondary particle, specifically, an interface between the NCM and the coating film is examined. The procedure is shown below.

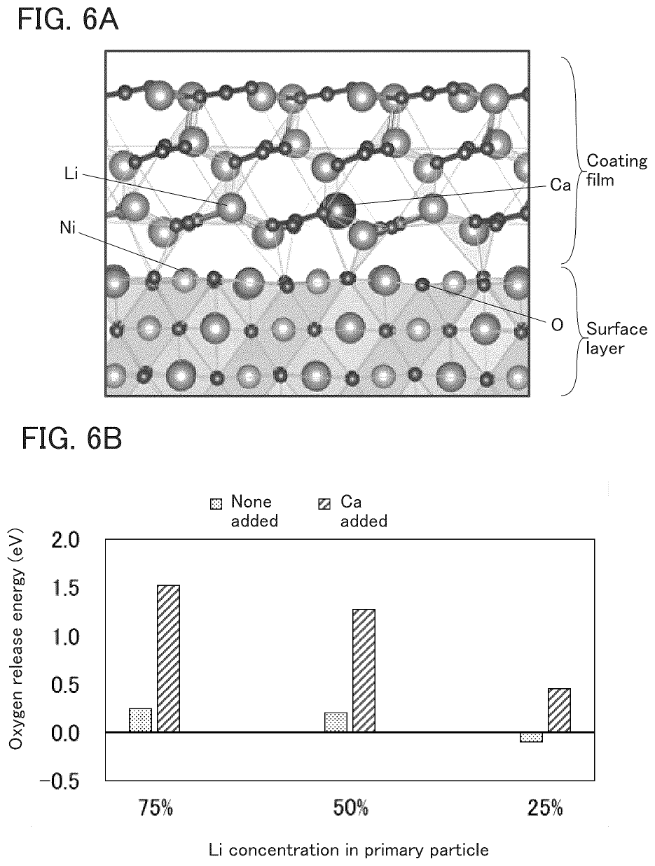

In order to simplify the evaluation model, a particle of the positive electrode active material is LNO which is a composite oxide of nickel and lithium serving as main components of NCM. It is assumed that a lithium carbonate crystal (partly containing calcium carbonate crystal) is formed as a coating film on the particle surface, and a model having a primary particle crystal (LNO: LiNiO₂, a space group R-3m)) adjacent to the coating film is created as illustrated in FIG. 6A. This model is a “none added” model and by replacing some of lithium of the lithium carbonate coating film with calcium of the “none added” model, a “Ca added” model is obtained. In both of these models, the energy necessary for oxygen to be released from the LNO interface is calculated by first-principles calculation using VASP. When a secondary battery is charged, the lithium concentration in the crystal (NCM) is lowered; thus, the oxygen release energy is calculated by changing the value of the lithium concentration.

The details of models that are used are shown in Table 2 below.

TABLE 2

| | |
|---|---|
| Software | VASP |
| Functional | GGA + U (van der Waals: DFT-D2) |
| Pseudopotential | PAW |
| Cutoff energy (eV) | 900 |
| U potential (eV) | Ni 5.26 |
| Number of atoms | LNO particle: Li 60, Ni 60, O 120 |
| | The above state is a 100% lithium |
| | concentration. |
| | Coating film portion of Li₂CO₃: Li 48, C |
| | 24, O 72 |
| | In the case where Ca is added, one of the |
| | above Li atoms is replaced with one Ca. |
| k-points | 1 × 1 × 1 |
| Calculation target | After a bulk structure of the particle |
| | portion of LCO is optimized, a vacuum of |
| | approximately 2 nm is placed regarding |
| | (104) as the surface; after Li₂CO₃ is placed |
| | in the surface portion, optimization is |
| | performed in a state where volume is |
| | fixed. |
| | After that, the energy difference in |
| | removing O from an interface portion |
| | between LNO and Li₂CO₃ is calculated |
| | and is obtained as the energy of oxygen |
| | release. |

In each of the cases where the lithium concentration of the primary particle crystal is set to be 75%, 50%, and 25%, the effect of inhibiting oxygen release in the case where a calcium element is added in the coating film of the model and in the case where no calcium element is added in the coating film of the model are evaluated by the oxygen release energy.

FIG. 6B shows the evaluation results. As shown in FIG. 6B, when the presence and absence of calcium in the coating film are compared, the value of the oxygen release energy in the case where calcium is present in the coating film is greater than that in the case where calcium is absent in the coating film. The high oxygen release energy indicates that there is an effect of inhibiting oxygen release from the particle.

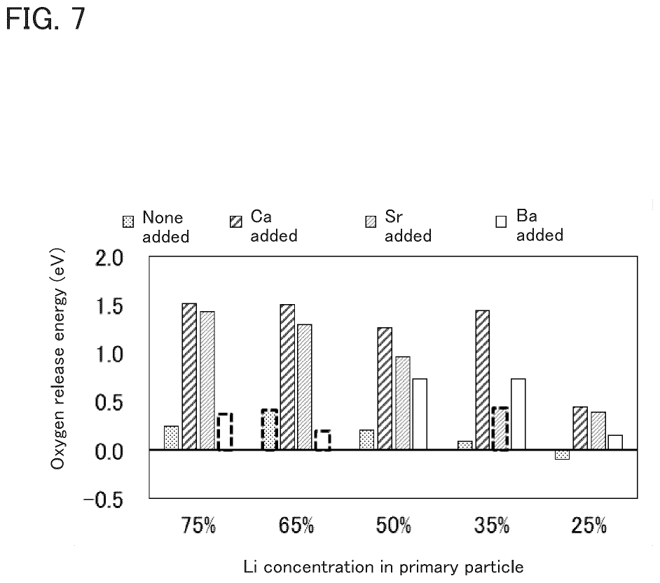

In addition, the same models and the same evaluation method are used to also evaluate strontium and barium and the results are shown in FIG. 7.

In FIG. 7, each of the lithium concentrations of the primary particle crystal is set to be 75%, 65%, 50%, 35%, and 25% in evaluation; and for comparison, the results shown in FIG. 6B are combined in FIG. 7 and shown as one evaluation result. Note that in FIG. 7, the calculation result shown by a dotted line is an estimated value.

Although an effect similar to that of calcium can also be obtained from strontium or barium as shown in FIG. 7, calcium has a greater effect of inhibiting oxygen release than strontium or barium. This is probably because calcium has a large influence on nearby oxygen, having an ion radius smaller than that of strontium or barium and a large surface charge density of an atom.

This embodiment can be freely combined with the other embodiments.

### Embodiment 2

In this embodiment, a coprecipitation apparatus that performs a coprecipitation method in the manufacturing methods in Embodiment 1 is described.

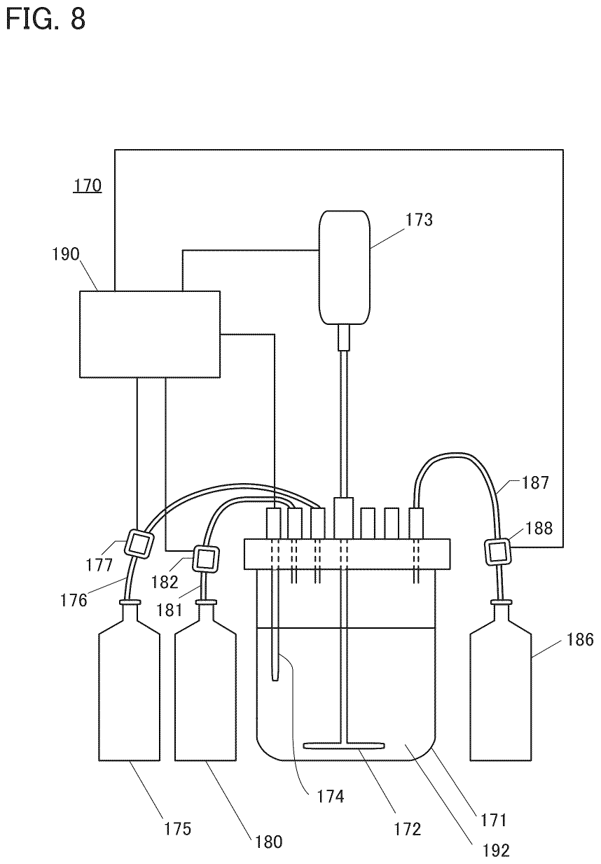

A coprecipitation synthesis apparatus 170 illustrated in FIG. 8 includes a reaction vessel 171, and the reaction vessel 171 includes a reaction container. A separable flask is used in the lower part of the reaction container and a separable cover is used in the upper part of the reaction container. The separable flask may be cylindrical or round type. A cylindrical separable flask has a flat bottom. The atmosphere of the reaction vessel 171 can be controlled with at least one inlet of the separable cover. For example, the atmosphere preferably contains nitrogen. In that case, it is preferable to make nitrogen flow in the reaction vessel 171. Nitrogen is preferably subjected to bubbling in an aqueous solution 192 in the reaction vessel 171. The coprecipitation synthesis apparatus 170 may be equipped with a reflux condenser connected to at least one inlet of the separable cover. This reflux condenser allows an atmosphere gas in the reaction vessel 171, e.g., nitrogen, to be ejected and water to return to the reaction vessel 171. In the atmosphere of the reaction vessel 171, it is acceptable that the amount of streaming air necessary for ejecting a gas generated by a pyrolytic reaction due to heat treatment is maintained.

The procedure of a coprecipitation method surrounded by the chain line in FIG. 4 is described with reference to FIG. 4 and FIG. 8.

First, the aqueous solution 894 (chelating agent) is put in the reaction vessel 171, and then the mixed solution 901 and the aqueous solution 893 (alkaline solution) are added into the reaction vessel 171. The aqueous solution 192 in FIG. 8 is in the state where adding has started. Note that the aqueous solution 894 is sometimes referred to as a filling liquid. The filling liquid is described as an adjustment liquid, and denotes an aqueous solution before a reaction, that is, an initial aqueous solution in some cases.

Other components of the coprecipitation synthesis apparatus 170 illustrated in FIG. 8 are described. The coprecipitation synthesis apparatus 170 includes a stirrer 172, a stirrer motor 173, a thermometer 174, a tank 175, a tube 176, a pump 177, a tank 180, a tube 181, a pump 182, a tank 186, a tube 187, a pump 188, and a control device 190.

The stirrer 172 can stir the aqueous solution 192 in the reaction vessel 171, and the stirrer motor 173 is included as a power source that makes the stirrer 172 rotate. The stirrer 172 includes a paddle-type agitator blade (denoted as a paddle blade), and the paddle blade includes two to six blades. The blade may have an inclination of greater than or equal to 40 degrees and less than or equal to 70 degrees.

The thermometer 174 can measure the temperature of the aqueous solution 192. The temperature of the reaction vessel 171 can be controlled using a thermoelectric element such that the temperature of the aqueous solution 192 is constant. An example of the thermoelectric element is a Peltier element. Although not shown, a pH meter is also provided in the reaction vessel 171, and the pH of the aqueous solution 192 can be measured.

Different aqueous solutions of source materials can be pooled in the tanks. For example, the tanks can be filled with the mixed solution 901 and the aqueous solution 893. A tank filled with the aqueous solution 894 serving as a filling liquid may be prepared. Each tank is equipped with a pump and an aqueous solution of a source material can be added into the reaction vessel 171 through a tube with use of the pump. The adding amount of the aqueous solution of a source material, that is the amount of the delivered liquid, can be controlled with the pump. In addition to the pump, a valve may be provided for the tube 176, and the adding amount of the aqueous solution of the source material, i.e., the amount of the delivered liquid may be controlled with the valve.

The control device 190 is electrically connected to the stirrer motor 173, the thermometer 174, the pump 177, the pump 182, and the pump 188, and can control the number of rotations of the stirrer 172, the temperature of the aqueous solution 192, and the adding amounts of the aqueous solutions of source materials.

The number of rotations of the stirrer 172, specifically, the number of rotations of the paddle blade is preferably, for example, greater than or equal to 800 rpm and less than or equal to 1200 rpm. The stirring is preferably performed while the aqueous solution 192 is heated at a temperature higher than or equal to 50° C. and lower than or equal to 90° C. In the stirring, the mixed solution 901 is preferably added into the reaction vessel 171 at a constant rate. Needless to say, the rotation number of the paddle blade is not limited to a constant number, and can be appropriately adjusted. For example, the rotation number can be changed depending on the liquid amount of the reaction vessel 171. Moreover, the liquid delivery speed of the mixed solution 901 can be adjusted. The liquid delivery speed can be controlled to keep the pH of the reaction vessel 171 constant. The liquid delivery speed may be controlled so that the aqueous solution 892 is added when the pH varies from a desired pH value during the addition of the mixed solution 901. The pH value is greater than or equal to 9.0 and less than or equal to 11.0, preferably greater than or equal to 10.0 and less than or equal to 10.5.

Through the above process, a reaction product is precipitated in the reaction vessel 171. The reaction product includes a compound containing at least nickel, cobalt, and manganese. This reaction can be referred to as co-precipitation or coprecipitation, and this step is referred to as a coprecipitation step in some cases.

This embodiment can be freely combined with the other embodiments.

### Embodiment 3

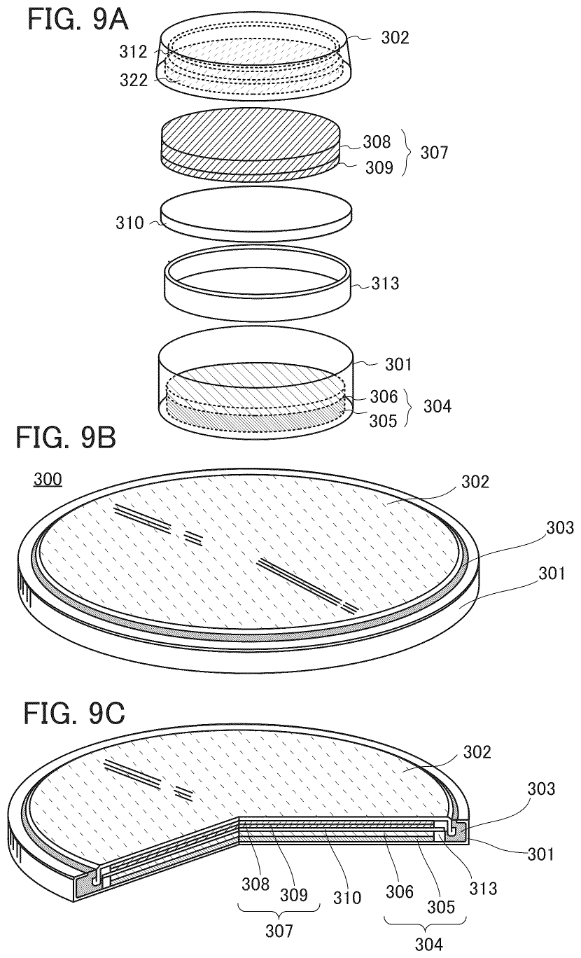

An example of a coin-type secondary battery is described. FIG. 9A is an exploded perspective view of a coin-type (single-layer flat type) secondary battery, FIG. 9B is an external view thereof, and FIG. 9C is a cross-sectional view thereof. Coin-type secondary batteries are mainly used in small electronic devices. In this specification, coin-type batteries include button-type batteries.

FIG. 9A is a schematic view showing overlap (a vertical relation and a positional relation) between components for easy understanding. Thus, FIG. 9A and FIG. 9B do not completely correspond with each other.

In FIG. 9A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 9A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 9B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to a liquid electrolyte, typified by nickel, aluminum, or titanium, an alloy of such a metal, or an alloy of such a metal and another metal (e.g., stainless steel) can be used. Covering with nickel and aluminum is preferable in order to prevent corrosion due to the liquid electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the liquid electrolyte: as illustrated in FIG. 9C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

With the above-described structure, the coin-type secondary battery 300 can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

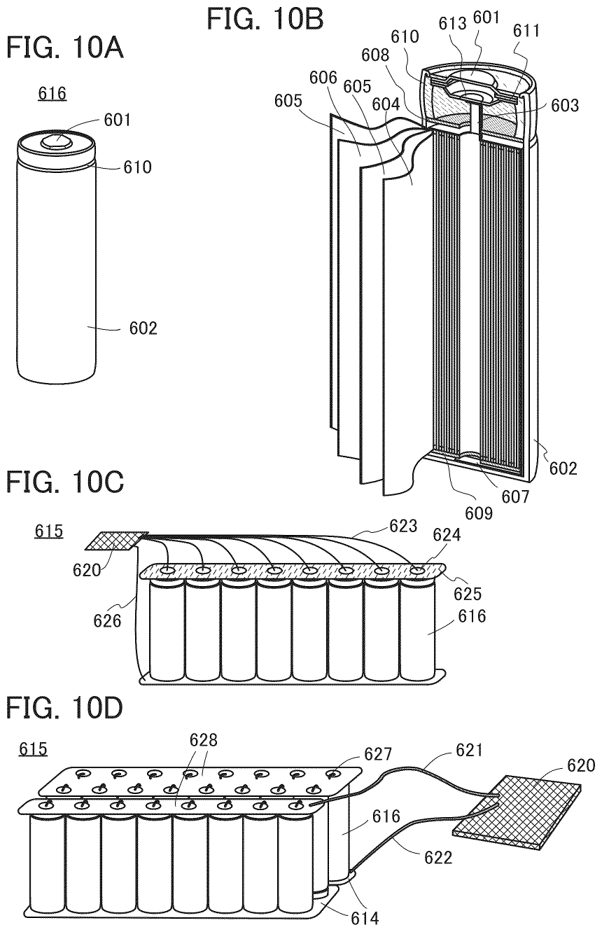

An example of a cylindrical secondary battery is described with reference to FIG. 10A. As illustrated in FIG. 10A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 10B schematically illustrates a cross section of a cylindrical secondary battery. The cylindrical secondary battery illustrated in FIG. 10B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 located therebetween is provided. Although not illustrated, the battery element is wound around a central axis. One end of the battery can 602 is closed and the other end thereof is open. For the battery can 602, a metal having corrosion resistance to a liquid electrolyte, typified by nickel, aluminum, or titanium, an alloy of such a metal, and an alloy of such a metal and another metal (e.g., stainless steel) can be used. The battery can 602 is preferably covered with nickel or aluminum in order to prevent corrosion due to the liquid electrolyte. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 10A to FIG. 10D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 200A described in Embodiment 1 is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material of aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

FIG. 10C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used.

FIG. 10D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 10D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

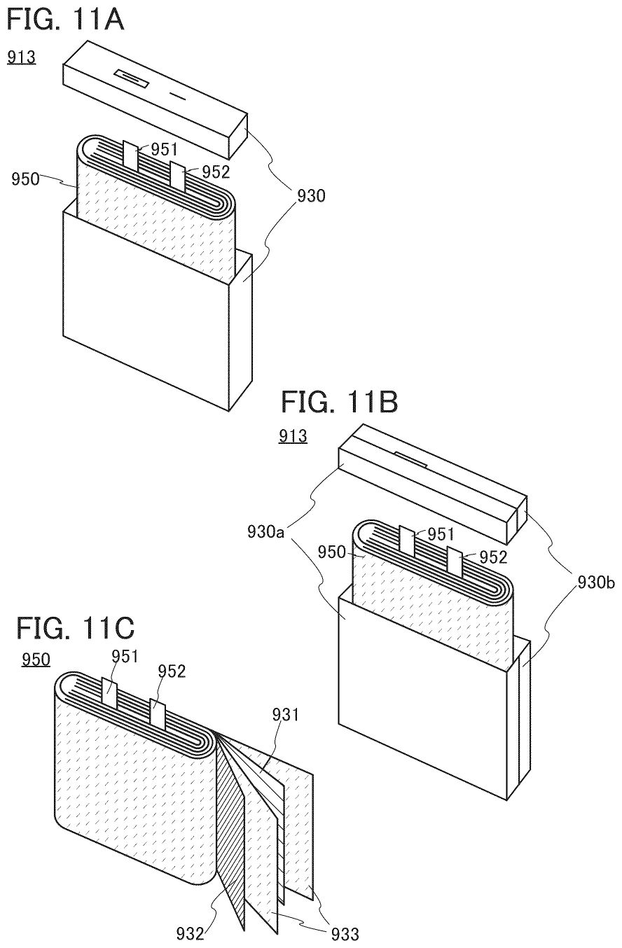

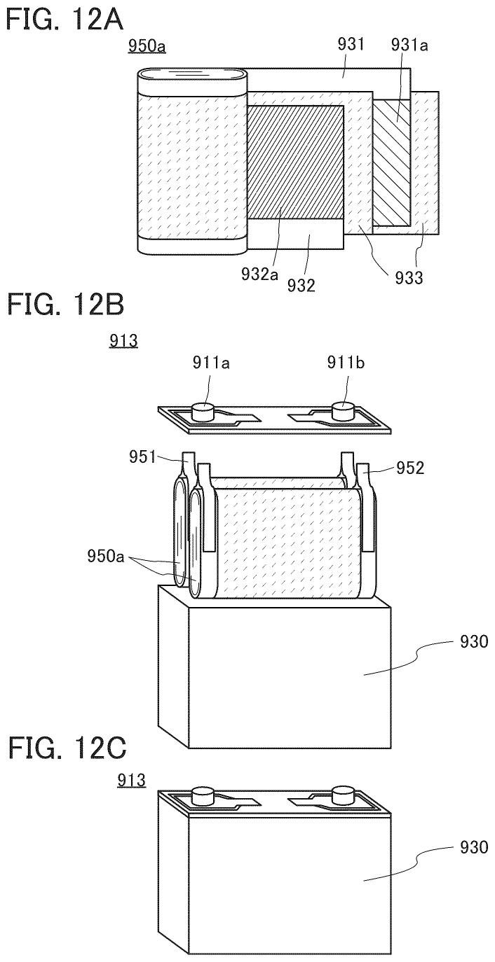

Structure examples of secondary batteries are described with reference to FIG. 11 and FIG. 12.

A secondary battery 913 illustrated in FIG. 11A includes a wound body 950 provided with a terminal 951 and a terminal 952 inside a housing 930. The wound body 950 is immersed in a liquid electrolyte inside the housing 930. The terminal 952 is in contact with the housing 930. The use of an insulator inhibits contact between the terminal 951 and the housing 930. Note that in FIG. 11A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 11B, the housing 930 illustrated in FIG. 11A may be formed using a plurality of materials. For example, in the secondary battery 913 illustrated in FIG. 11B, a housing 930a and a housing 930b are attached to each other, and the wound body 950 is provided in a region surrounded by the housing 930a and the housing 930b.

For the housing 930a, an insulating material typified by an organic resin can be used. In particular, when a material typified by an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 11C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 12A to FIG. 12C, the secondary battery 913 may include a wound body 950a. The wound body 950a illustrated in FIG. 12A includes the negative electrode 931, the positive electrode 932, and the separators 933. The negative electrode 931 includes a negative electrode active material layer 931a. The positive electrode 932 includes a positive electrode active material layer 932a.

The positive electrode active material 200A described in Embodiment 1 is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931 a is preferably larger than that of the positive electrode active material layer 932a. The wound body 950a having such a shape is preferable because of its high level of safety and high productivity.

As illustrated in FIG. 12B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 12C, the wound body 950a and a liquid electrolyte are covered with the housing 930, whereby the secondary battery 913 is completed. The housing 930 is preferably provided with a safety valve and an overcurrent protection element. In order to prevent the battery from exploding, a safety valve is a valve to be released when the internal pressure of the housing 930 reaches a predetermined pressure.

As illustrated in FIG. 12B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 11A to FIG. 11C can be referred to for the other components of the secondary battery 913 illustrated in FIG. 12A and FIG. 12B.

### <Laminated Secondary Battery>

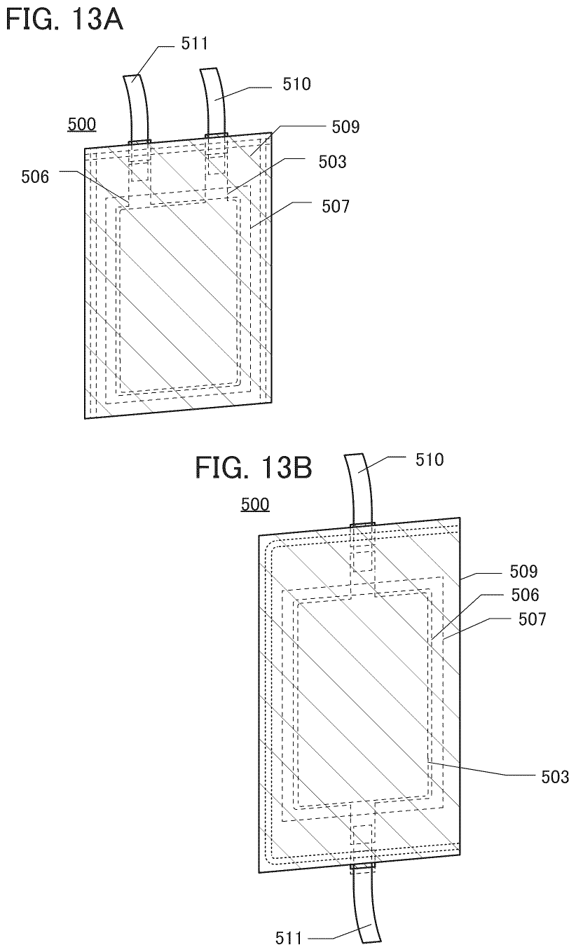

Next, examples of the appearance of a laminated secondary battery are illustrated in FIG. 13A and FIG. 13B. In FIG. 13A and FIG. 13B, a positive electrode 503, a negative electrode 506, a separator 507, an exterior body 509, a positive electrode lead electrode 510, and a negative electrode lead electrode 511 are included.

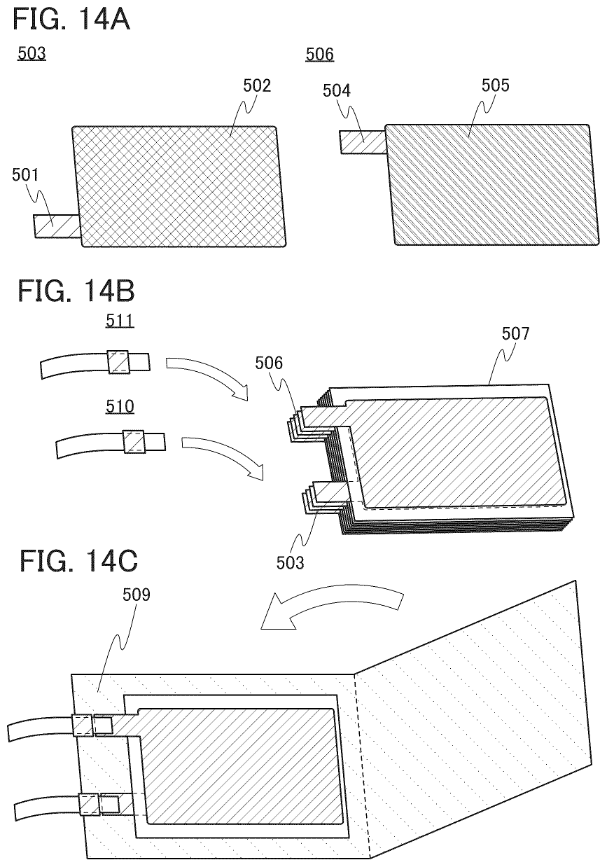

FIG. 14A illustrates the appearance of the positive electrode 503 and the negative electrode 506. The positive electrode 503 includes a positive electrode current collector 501, and a positive electrode active material layer 502 is formed on the surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on the surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 14A.

### <Fabrication Method of Laminated Secondary Battery>

Here, an example of a fabrication method of the laminated secondary battery whose external view is shown in FIG. 13A is described with reference to FIG. 14B and FIG. 14C.

First, the negative electrode 506, the separator 507, and the positive electrode 503 are stacked. FIG. 14B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 14C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that a liquid electrolyte can be introduced later.

Next, the liquid electrolyte (not illustrated) is introduced into the exterior body 509 from the inlet of the exterior body 509. The liquid electrolyte is preferably introduced in a reduced pressure atmosphere or in an inert atmosphere. Lastly, the inlet is sealed by bonding. In this manner, the laminated secondary battery 500 can be fabricated.

The positive electrode active material 200A described in Embodiment 1 is used for the positive electrode 503, whereby the secondary battery 500 can have high capacity, high charge and discharge capacity, and excellent cycle performance.

### [Examples of Battery Pack]

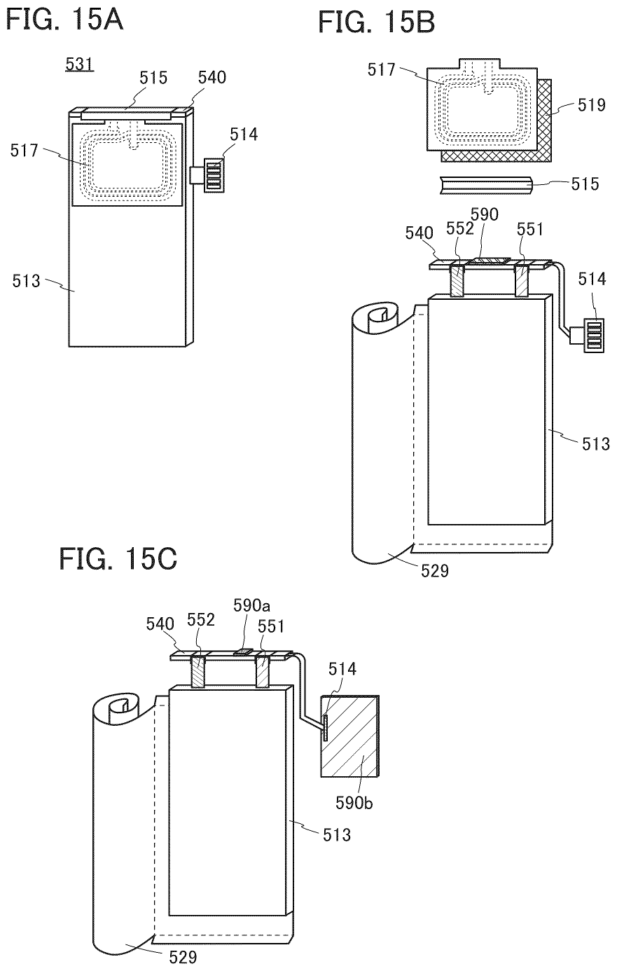

Examples of a secondary battery pack of one embodiment of the present invention that is capable of wireless charging using an antenna will be described with reference to FIG. 15A to FIG. 15C.

FIG. 15A is a diagram illustrating the appearance of a secondary battery pack 531 that has a rectangular solid shape with a small thickness (also referred to as a flat plate shape with a certain thickness). FIG. 15B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 15B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 15C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, an antenna typified by a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents of this embodiment can be freely combined with the contents of the other embodiments.

### Embodiment 4

In this embodiment, an example in which an all-solid-state battery is fabricated using the positive electrode active material 200A described in Embodiment 1 will be described.

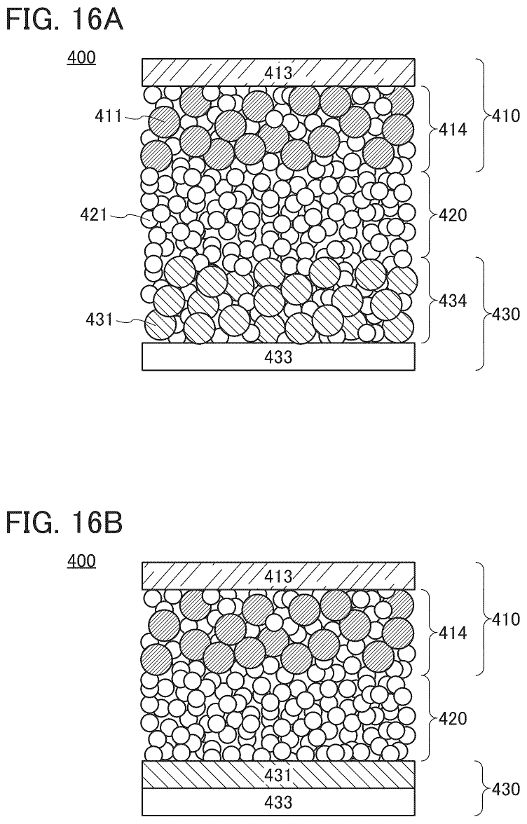

As illustrated in FIG. 16A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 200A described in Embodiment 1 is used as the positive electrode active material 411. The positive electrode active material layer 414 may include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used as the negative electrode active material 431, metal lithium does not need to be processed into particles: thus, the negative electrode 430 that does not include the solid electrolyte 421 can be formed, as illustrated in FIG. 16B. FIG. 16B illustrates an example in which the negative electrode active material 431 is deposited by a sputtering method. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (Li₁₀GeP₂S₁₂ or Li_{3.25}Ge_{0.25}P_{0.75}S₄), sulfide glass (70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (Li₇P₃S₁₁ or Li_{3.25}P_{0.95}S₄). The sulfide-based solid electrolyte has advantages of high conductivity of some materials, low-temperature synthesis, and ease of maintaining a path for electrical conduction after charge and discharge because of its relative softness.

The oxide-based solid electrolyte includes a material with a perovskite crystal structure (La_{2/3-x}Li₃ₓTiO₃), a material with a NASICON crystal structure (Li_{1-Y}Al_{Y}Ti_{2-Y}(PO₄)₃), a material with a garnet crystal structure (Li₇La₃Zr₂O₁₂), a material with a LISICON crystal structure (Li₁₄ZnGe₄O₁₆), LLZO (Li₇La₃Zr₂O₁₂), oxide glass (Li₃PO₄—Li₄SiO₄ or 50Li₄SiO₄·50Li₃BO₃), or oxide-based crystallized glass (Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

The halide-based solid electrolyte includes LiAlCl₄, LisInBr₆, LiF, LiCl, LiBr, or LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0 [ x [1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification, a NASICON crystal structure refers to a compound that is represented by M₂(XO₄)₃ (M: transition metal: X: S, P, As, Mo, or W) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

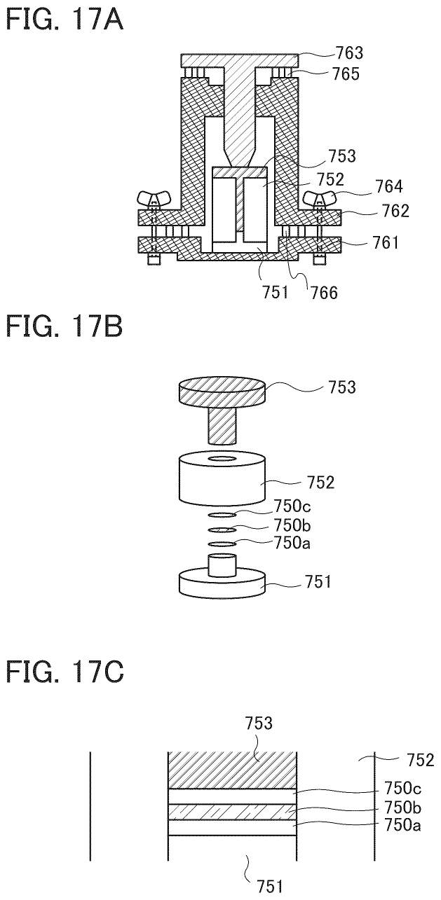

FIG. 17 illustrates an example of a cell for evaluating materials of an all-solid-state battery, for example.

FIG. 17A is a cross-sectional schematic view of the evaluation cell, and the evaluation cell includes a lower component 761, an upper component 762, and a fixation screw or a butterfly nut 764 for fixing these components: by rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 17B is an enlarged perspective view of the evaluation material and its vicinity.

A stack of a positive electrode 750a, a solid electrolyte layer 750b, and a negative electrode 750c is illustrated here as an example of the evaluation material, and its cross-sectional view is illustrated in FIG. 17C. Note that the same portions in FIG. 17A to FIG. 17C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

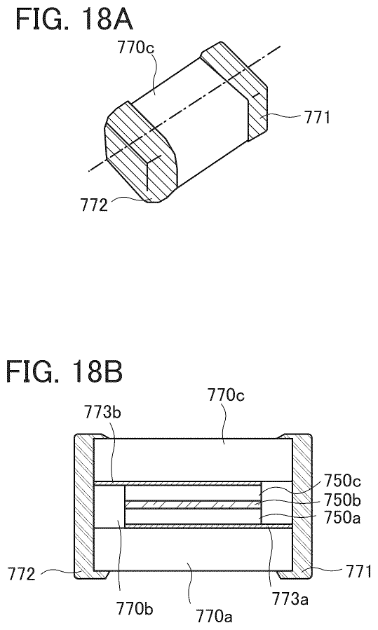

FIG. 18A illustrates a perspective view of a secondary battery of one embodiment of the present invention that has an exterior body and a shape different from those in FIG. 17. The secondary battery in FIG. 18A includes external electrodes 771 and 772 and is sealed with an exterior body including a plurality of package components.

FIG. 18B illustrates an example of a cross section along the dashed-dotted line in FIG. 18A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 200A described in Embodiment 1 can achieve an all-solid-state secondary battery having excellent cycle performance and a favorable output characteristics.

The contents of this embodiment can be combined with the contents of the other embodiments as appropriate.

### Embodiment 5

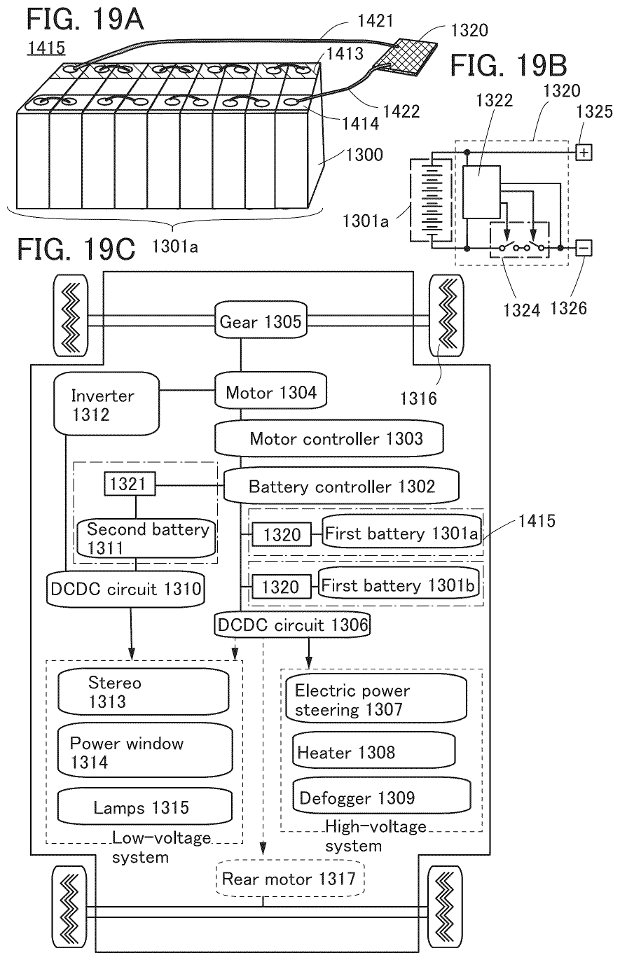

This embodiment is an example different from the cylindrical secondary battery of FIG. 10D. An example of application to an electric vehicle (EV) is described with reference to FIG. 19C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed: the capacity of the second battery 1311 is lower than that of the first batteries 1301a and 1301b.

The internal structure of the first battery 1301a may be the wound structure illustrated in FIG. 11A or FIG. 12C or the stacked-layer structure illustrated in FIG. 13A or FIG. 13B. Alternatively, the first battery 1301a may be the all-solid-state battery in Embodiment 4. The use of the all-solid-state battery in Embodiment 4 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (a stereo 1313, a power window 1314, and lamps 1315) through a DCDC circuit 1310.

The first battery 1301a will be described with reference to FIG. 19A.

FIG. 19A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (a road surface), the plurality of secondary batteries are preferably fixed by the fixing portions 1413 and 1414 and a battery container box. Furthermore, the one electrode is electrically connected to a control circuit portion 1320 through a wiring 1421. The other electrode is electrically connected to the control circuit portion 1320 through a wiring 1422.

FIG. 19B illustrates an example of a block diagram of the battery pack 1415 illustrated in FIG. 19A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside and the upper limit of output current to the outside. The range from the lower limit voltage to the upper limit voltage of the secondary battery falls within the recommended voltage range: when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon: the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), or GaOx (gallium oxide, where x is a real number greater than 0)).

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium-ion secondary batteries in that they have a larger amount of self-discharge and are more likely to deteriorate due to a phenomenon called sulfation. There is an advantage that the second battery 1311 can be maintenance-free when a lithium-ion secondary battery is used; however, in the case of long-term use, for example three years or more, anomaly that cannot be determined at 30) the time of manufacturing might occur. In particular, when the second battery 1311 that starts the inverter becomes inoperative, the motor cannot be started even when the first batteries 1301a and 1301b have remaining capacity: thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 4 may be used. The use of the all-solid-state battery in Embodiment 4 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging.

The battery controller 1302 can set the charge voltage and charge current of the first batteries 1301a and 1301b. The battery controller 1302 can set charge conditions in accordance with charge characteristics of a secondary battery to be used, so that fast charge can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used: to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations have a 100 V outlet, a 200 V outlet, or a three-phase 200 V outlet with 50 KW. Furthermore, charge can be performed with electric power supplied from external charge equipment by a contactless power feeding method.

For fast charge, secondary batteries that can withstand high-voltage charge have been desired to perform charge in a short time.

The above-described secondary battery in this embodiment uses the positive electrode active material 200A described in Embodiment 1. Moreover, it is possible to achieve a secondary battery in which graphene is used as a conductive additive, an electrode layer is formed thick to increase the loading amount while suppressing a reduction in capacity, and the electrical characteristics are significantly improved in synergy with maintenance of high capacity. This secondary battery is particularly effectively used in a vehicle: it is possible to provide a vehicle that has a long cruising range, specifically one charge mileage of 500 km or greater, without increasing the proportion of the weight of the secondary battery to the weight of the entire vehicle. The use of the positive electrode active material 200A described in Embodiment 1 in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 10D, FIG. 12C, and FIG. 19A on vehicles can achieve next-generation clean energy vehicles typified by hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft typified by fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

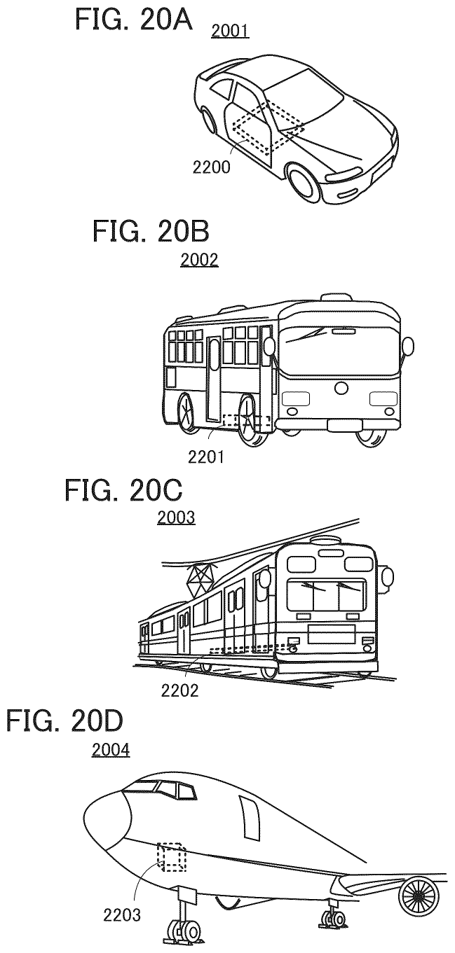

FIG. 20A to FIG. 20D illustrate examples of transport vehicles using one embodiment of the present invention. A motor vehicle 2001 illustrated in FIG. 20A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 3 is provided at one position or several positions. The motor vehicle 2001 illustrated in FIG. 20A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system and a contactless charge system. In charging, a given method of CHAdeMO (registered trademark) or Combined Charging System may be employed as a charge method and the standard of a connector, as appropriate. A secondary battery may be a charging station provided in a commerce facility or a power source in a house. For example, with the use of the plug-in system, the power storage device mounted on the motor vehicle 2001 can be charged by being supplied with electric power from the outside. Charge can be performed by converting AC power into DC power through a converter typified by an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 20B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage, for example. A battery pack 2201 has the same function as that in FIG. 20A except for the number of secondary batteries configuring the secondary battery module: thus, the description is omitted.

FIG. 20C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. With the use of a secondary battery including a positive electrode using the positive electrode active material 200A described in Embodiment 1, a secondary battery having excellent rate performance and charge and discharge cycle performance can be manufactured, which can contribute to higher performance and a longer lifetime of the transport vehicle 2003. A battery pack 2202 has the same function as that in FIG. 20A except for the number of secondary batteries configuring the secondary battery module; thus, the description is omitted.

FIG. 20D illustrates an aircraft 2004 having a combustion engine as an example. The aircraft 2004 illustrated in FIG. 20D can be regarded as a kind of transport vehicles since it is provided with wheels for takeoff and landing, and has a battery pack 2203 including a secondary battery module and a charge control device: the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 20A except for the number of secondary batteries configuring the secondary battery module: thus, the description is omitted.

The contents of this embodiment can be combined with the contents of the other embodiments as appropriate.

### Embodiment 6

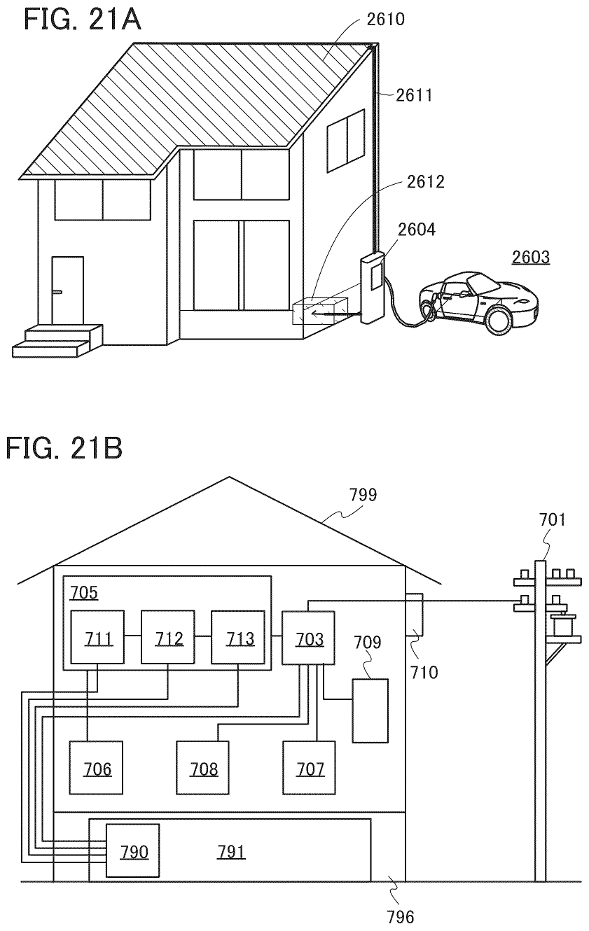

In this embodiment, examples in which the secondary battery of one embodiment of the present invention is mounted on a building will be described with reference to FIG. 21A and FIG. 21B.

A house illustrated in FIG. 21A includes a power storage device 2612 including the secondary battery of one embodiment of the present invention and a solar panel 2610. The power storage device 2612 is electrically connected to the solar panel 2610 through a wiring 2611. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure.

FIG. 21B illustrates an example of a power storage device of one embodiment of the present invention. As illustrated in FIG. 21B, a power storage device 791 of one embodiment of the present invention is provided in an underfloor space 796 of a building 799. The power storage device 791 may be provided with the control circuit described in Embodiment 5, and the use of a secondary battery including a positive electrode using the positive electrode active material 200A described in Embodiment 1 enables the power storage device 791 to have a long lifetime.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device typified by a TV or a personal computer. The power storage load 708 is, for example, an electric device typified by a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device typified by a TV or a personal computer through the router 709. Furthermore, it can be checked with a portable electronic terminal typified by a smartphone or a tablet through the router 709. With the indicator 706, the electric device, or the portable electronic terminal, for example, the demand for electric power depending on a time period (or per hour) that is predicted by the predicting portion 712 can be checked.

The contents of this embodiment can be combined with the contents of the other embodiments as appropriate.

### Embodiment 7

In this embodiment, examples in which a motorcycle or a bicycle is provided with the power storage device of one embodiment of the present invention will be described.

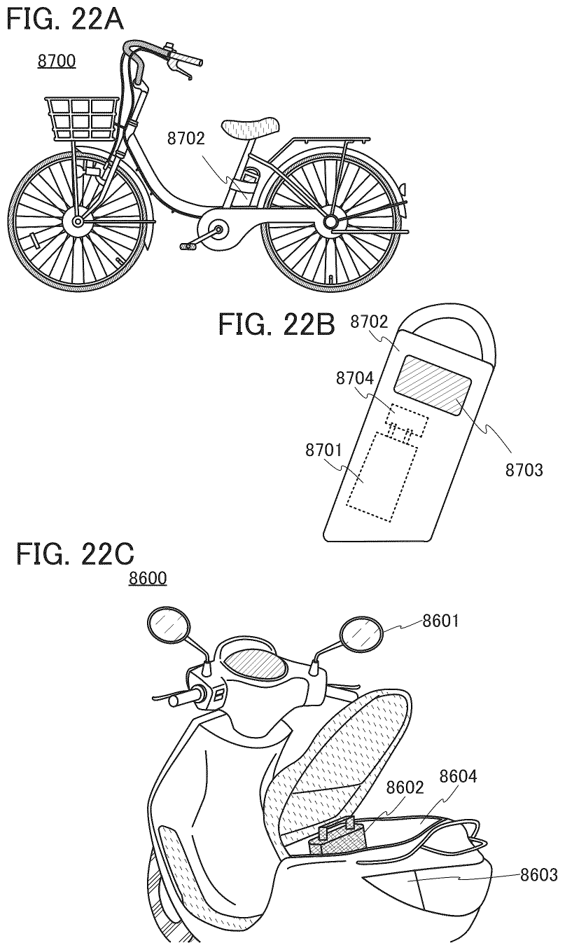

FIG. 22A illustrates an example of an electric bicycle using the power storage device of one embodiment of the present invention. The power storage device of one embodiment of the present invention can be used for an electric bicycle 8700 illustrated in FIG. 22A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 22B illustrates the state where the power storage device 8702 is detached from the bicycle. A plurality of storage batteries 8701 included in the power storage device of one embodiment of the present invention are incorporated in the power storage device 8702, and the remaining battery capacity can be displayed on a display portion 8703. The power storage device 8702 includes a control circuit 8704 capable of charge control or anomaly detection for the secondary battery, which is exemplified in Embodiment 5. The control circuit 8704 is electrically connected to a positive electrode and a negative electrode of the storage battery 8701. The control circuit 8704 may be provided with the small solid-state secondary battery illustrated in FIG. 18A and FIG. 18B. When the small solid-state secondary battery illustrated in FIG. 18A and FIG. 18B is provided in the control circuit 8704, electric power can be supplied to store data in a memory circuit included in the control circuit 8704 for a long time. When the control circuit 8704 is used in combination with the secondary battery using the positive electrode active material 200A described in Embodiment 1 in the positive electrode, the synergy on safety can be obtained.

FIG. 22C illustrates an example of a motorcycle using the power storage device of one embodiment of the present invention. A motor scooter 8600 illustrated in FIG. 22C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 200A described in Embodiment 1 can contribute to a long lifetime.

In the motor scooter 8600 illustrated in FIG. 22C, the power storage device 8602 can be stored in an under-seat storage unit 8604. The power storage device 8602 can be stored in the under-seat storage unit 8604 even with a small size.

The contents of this embodiment can be combined with the contents of the other embodiments as appropriate.

### Embodiment 8

In this embodiment, examples of electronic devices each including the secondary battery of one embodiment of the present invention will be described. Examples of the electronic device including the secondary battery include a television device (also referred to as a television or a television receiver), a monitor for a computer, a digital camera, a digital video camera, a digital photo frame, a mobile phone (also referred to as a cellular phone or a mobile phone device), a portable game machine, a portable information terminal, an audio reproducing device, and a large-sized game machine typified by a pachinko machine. Examples of the portable information terminal include a laptop personal computer, a tablet terminal, an e-book reader, and a mobile phone.

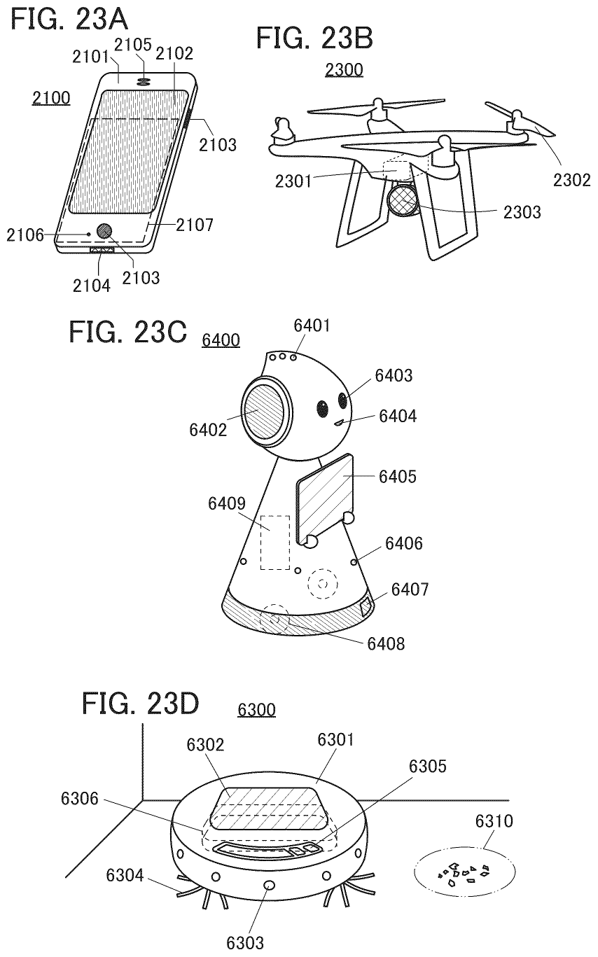

FIG. 23A illustrates an example of a mobile phone. A mobile phone 2100 includes a housing 2101 in which a display portion 2102 is incorporated, operation buttons 2103, an external connection port 2104, a speaker 2105, or a microphone 2106. The mobile phone 2100 includes a secondary battery 2107. The use of the secondary battery 2107 including a positive electrode using the positive electrode active material 200A described in Embodiment 1 achieves high capacity and a structure that accommodates space saving due to a reduction in size of the housing.

The mobile phone 2100 is capable of executing a variety of applications typified by mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor typified by a fingerprint sensor, a pulse sensor, or a temperature sensor, a touch sensor, a pressure sensitive sensor, or an acceleration sensor is preferably mounted, for example.

FIG. 23B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 200A described in Embodiment 1 exhibits excellent cycle performance and has a high level of safety, and thus can be used safely for a long time over a long period of time and is preferable as the secondary battery included in the unmanned aircraft 2300.

FIG. 23C illustrates an example of a robot. A robot 6400 illustrated in FIG. 23C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, and an arithmetic device.

The microphone 6402 has a function of detecting a speaking voice of a user and an environmental sound. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 200A described in Embodiment 1 exhibits excellent cycle performance and has a high level of safety, and thus can be used safely for a long time over a long period of time and is preferable as the secondary battery 6409 included in the robot 6400.

FIG. 23D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, or a variety of sensors. Although not illustrated, the cleaning robot 6300 is provided with a tire or an inlet. The cleaning robot 6300 is self-propelled, detects dust 6310, and sucks up the dust through the inlet provided on the bottom surface.

For example, the cleaning robot 6300 can determine whether there is an obstacle typified by a wall, furniture, or a step by analyzing images taken by the cameras 6303. In the case where an object like a wiring that is likely to be caught in the brush 6304 is detected by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 200A described in Embodiment 1 exhibits excellent cycle performance and has a high level of safety, and thus can be used safely for a long time over a long period of time and is preferable as the secondary battery 6306 included in the cleaning robot 6300.

The contents of this embodiment can be combined with the contents of the other embodiments as appropriate.

### Embodiment 9

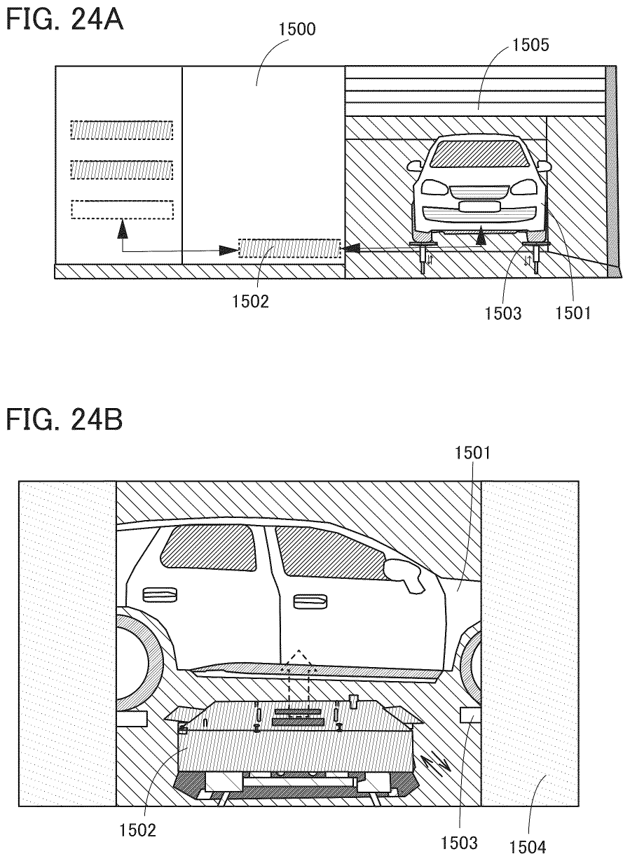

In this embodiment, an example in which the secondary battery of one embodiment of the present invention is mounted on a car will be described with reference to FIG. 24A and FIG. 24B.

FIG. 24A illustrates a schematic view of a station 1500 capable of exchanging secondary batteries. The station 1500 includes a mechanism 1503 for lifting a car, a mechanism for attaching and detaching a secondary battery, a mechanism for charging a secondary battery, and a mechanism for storing secondary batteries.

In addition, the station 1500 includes a garage door 1505, so that the entrance/exit for the car can be opened and closed. The secondary battery exchanging operation might cause electrocution, and thus it is preferable that the garage door 1505 be closed and the entrance/exit for the car be closed.

After a driver or an operator parks a car 1501 at a predetermined position of the station 1500, the driver or the operator steps out of the car and operates the mechanism 1503 for lifting the car inside the station 1500, so that the car 1501 is lifted. Then, the driver or the operator detaches a secondary battery of the car 1501 using the mechanism for attaching and detaching the secondary battery. The detached secondary battery is moved to be stored and is charged by the mechanism for storing the secondary batteries. Then, the driver or the operator attaches a new secondary battery that is already charged to the car 1501 using the mechanism for attaching and detaching the secondary battery.

FIG. 24B is a schematic view illustrating a state just prior to attaching a new secondary battery 1502 to the car 1501 using the mechanism for attaching and detaching the secondary battery. Note that partition plates 1504 are provided on both sides.

Although FIG. 24A and FIG. 24B illustrate a mechanism for lifting and lowering tires as the mechanism 1503 for lifting the car, there is no particular limitation and a mechanism for lifting and lowering a lower portion of a car body of the car 1501 may be employed. In the case where the mechanism for lifting and lowering the tires is employed, a suspension is provided between the tires and the car body, and thus when the tires are pushed from the bottom using the mechanism for attaching and detaching the secondary battery, the car body is also lifted and attaching the secondary battery might not be successful. Even in the mechanism for lifting and lowering the lower portion of the car body of the car 1501, attaching the secondary battery might not be successful when the car body is lightweight and the car 1501 becomes imbalanced. Accordingly, it is preferable that the alignment of the car 1501 and the secondary battery 1502 or the alignment control of the mechanism for attaching and detaching the secondary battery be precisely performed.

The station 1500 capable of exchanging the secondary batteries illustrated in FIG. 24A and FIG. 24B can save the charging time although some exchanging time is required in exchanging into a new secondary battery. In addition, even when the secondary battery becomes old and deteriorates, it can be exchanged with another secondary battery that is charged as needed. This leads to a longer lifetime of the car 1501 regardless of the deterioration of the secondary battery.

The station 1500 capable of exchanging secondary batteries can be provided at a private residence, a shared space, or a car dealer.

As a system for using the station 1500 capable of exchanging the secondary batteries, a service in which a secondary battery that is used is exchanged with another secondary battery that is charged at the station 1500 provided at a private residence, a shared space, or a car dealer is provided. With such a system, in the case where the capacity of a secondary battery is extremely reduced due to driving, a problem of having difficulties moving the car from a charging spot for a couple of hours or half of a day to charge the secondary battery can be solved. With use of the station 1500, the car can be driven when the secondary battery is exchanged with another secondary battery after driving.

A secondary battery stored in the station 1500 is charged repeatedly, and thus a secondary battery having excellent cycle performance is preferable. In particular, the positive electrode active material 200A obtained in Embodiment 1 is NCM and contains calcium in the coating film of the primary particle or the coating film of the secondary particle, so that oxygen release is less likely to occur and excellent cycle performance is obtained: thus, the positive electrode active material 200A is optimal.

This embodiment can be freely combined with the other embodiments.

### Example

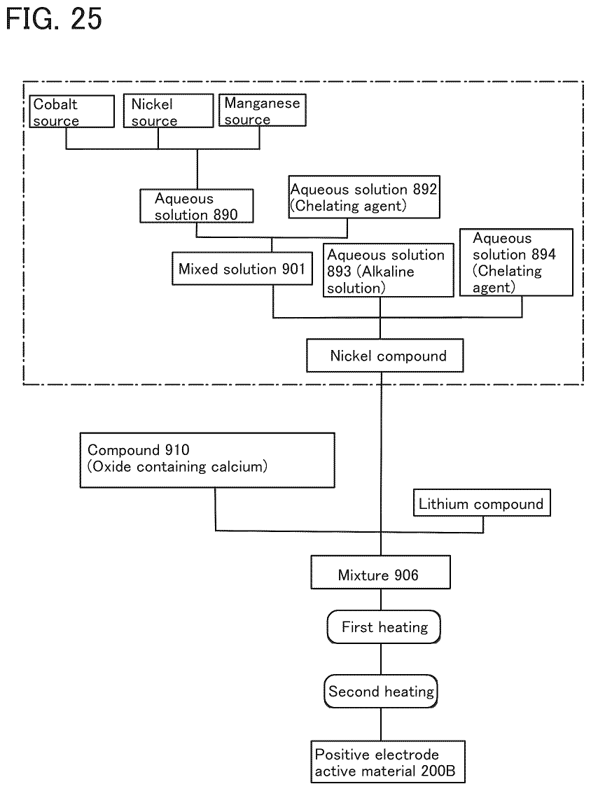

In this example, eight kinds of samples including different secondary particles were fabricated in accordance with the manufacturing flow chart shown in FIG. 4 and the manufacturing flow chart shown in FIG. 25. In addition, two kinds of comparative samples were prepared, and evaluation was performed on ten kinds of samples in total.

Samples obtained in accordance with FIG. 4 described in Embodiment 1 are referred to as “post-addition (post)”, and samples each having a calcium concentration of 0.5 atm %, 1 atm %, 2 atm %, and 5 atm % were formed. Here, the calcium concentration was adjusted such that the calcium concentration was 0.5 atm %, 1 atm %, 2 atm %, and 5 atm % with respect to the nickel compound (containing cobalt and manganese). The positive electrode active material 200A that was obtained is NCM represented by Li_{1.01}Ni_{X}Co_{Y}Mn_{Z}O₂ (note that X+Y+Z=1, X=0.8, Y=0.1, and Z=0.1) and contains calcium in the coating film of the primary particle or the coating film of the secondary particle. Note that in this example, the lithium concentration was adjusted such that the lithium concentration was set to be 1.01 atm % with respect to the nickel compound (containing cobalt and manganese).

A sample was fabricated in accordance with the manufacturing flow chart shown in FIG. 25.

Here, the manufacturing flow chart shown in FIG. 25 is described.

Note that since the manufacturing flow chart shown in FIG. 25 and the manufacturing flow chart in FIG. 4 are only partly different from each other, detailed description of the same process is omitted here. The steps up to where the nickel compound serving as the coprecipitation precursor is obtained by the coprecipitation method is the same as the manufacturing flow chart in FIG. 4.

In the manufacturing flow chart shown in FIG. 25, a lithium compound (lithium hydroxide) and a calcium compound (calcium carbonate in this example) were mixed with the nickel compound (containing cobalt and manganese) serving as the coprecipitation precursor, and then heating was performed. In this example, the lithium compound was adjusted as appropriate such that the molar ratio was 1.01 with respect to the nickel compound (containing cobalt and manganese) serving as the coprecipitation precursor. Furthermore, calcium carbonate was weighed out and mixed such that the calcium concentration was each 0.5 atm %, 1 atm %, 2 atm %, and 5 atm % with respect to the nickel compound (containing cobalt and manganese) serving as the coprecipitation precursor, whereby a mixture 906 was obtained. For the mixing, a mortar or a stirring mixer was used.

Next, first heating was performed. An electric furnace or a rotary kiln furnace can be used as a firing device for the first heating.

The first heating temperature is preferably higher than 662° C. and lower than or equal to 1050° C. The duration of the first heating is preferably longer than or equal to 1 hour and shorter than or equal to 20 hours.

Sequentially, the particles were ground or crushed in a mortar to have a uniform particle diameter, and then collected. Furthermore, classification may be performed using a sieve. In this example, a crucible made of aluminum oxide (also referred to as alumina) with a purity of 99.9% was used. It is suitable to collect the heated materials after the materials are transferred from the crucible to a mortar in order to prevent impurities from entering the materials. The mortar is suitably made of a material which is less likely to release impurities. Specifically, it is suitable to use a mortar made of alumina with a purity of 90% or higher, preferably 99% or higher.

Next, second heating was performed. An electric furnace or a rotary kiln furnace can be used as a firing device for the second heating.

The second heating temperature is preferably higher than 662° C. and lower than or equal to 1050° C. The duration of the second heating is preferably longer than or equal to 1 hour and shorter than or equal to 20 hours. The second heating is preferably performed in an oxygen atmosphere, and in particular, preferably performed while oxygen is supplied. For example, the flow rate of oxygen is 10 L/min. per liter of inner capacity of the furnace. Specifically, the heating is preferably performed in a state where a container containing the mixture 906 is covered with a lid.

Sequentially, the particles were ground or crushed in a mortar to have a uniform particle diameter, and then collected. Furthermore, classification may be performed using a sieve.

Through the above steps, a positive electrode active material 200B can be manufactured.

Samples obtained in accordance with FIG. 25 above are referred to as “same time addition (same)”, and samples each having a calcium concentration of 0.5 atm %, 1 atm %, 2 atm %, and 5 atm % were formed. The positive electrode active material 200B that was obtained is NCM represented by Li_{1.01}Ni_{X}Co_{Y}Mn_{Z}O₂ (note that X+Y+Z=1, X=0.8, Y=0.1, and Z=0.1) and contains calcium in the coating film of the primary particle or the coating film of the secondary particle.

As comparative examples, a sample in which no calcium compound was added in the manufacturing flow chart in FIG. 4 and a sample in which no calcium compound was added in the manufacturing flow chart in FIG. 25 were used. The difference in the conditions of the samples of these two comparative examples is whether third heating was performed or not performed.

The above-described samples which were formed by changing the manufacturing conditions of secondary particles, i.e., the secondary particle with calcium added at 0.5 atm %, the secondary particle with calcium added at 1 atm %, the secondary particle with calcium added at 2 atm %, and the secondary particle with calcium added at 5 atm % were subjected to XRD analysis, and the size of the a-axis and the size of the c-axis were calculated. For comparison, XRD analysis of the secondary particle with no calcium added was also performed, and the size of the a-axis and the size of the c-axis were calculated.

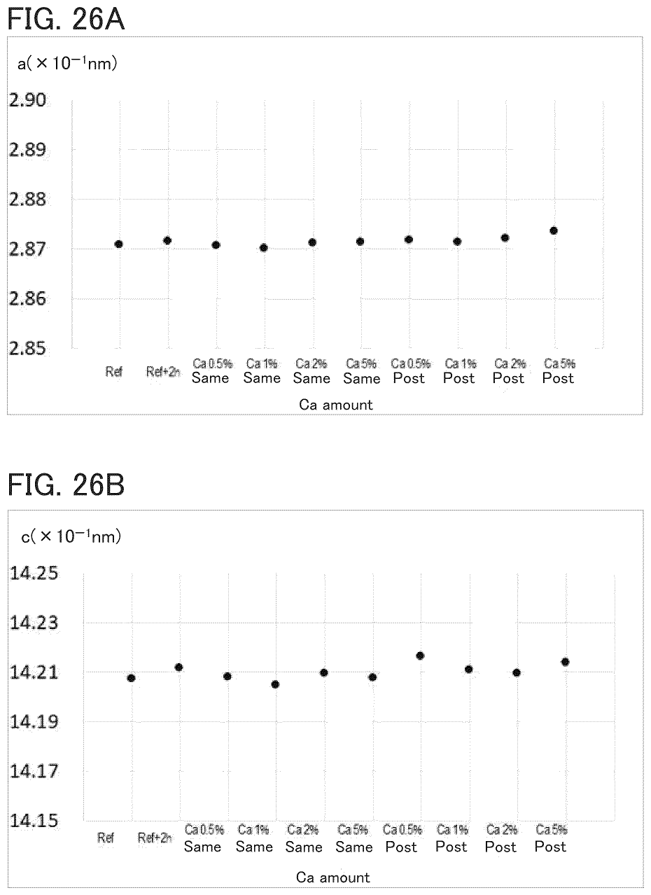

The calculation results are shown in FIG. 26.

These results show that there is almost no difference in the size of the a-axis and the size of the c-axis in all the samples. In the case where calcium, which has a large ion radius, is contained in a crystal so as to form a solid solution with NCM, the size of the a-axis and the size of the c-axis are increased in accordance with the adding amount, and the change thereof is supposed to confirm the presence of calcium. Accordingly, regardless of the difference in the manufacturing flows, it can be confirmed that no calcium was contained in a primary particle, which is a crystal, depending on the manufacturing flow. In other words, it can be said that calcium was neither contained nor detected in the primary particle of the positive electrode active material 200A and the positive electrode active material 200B.

### <XRD>

The XRD measurement conditions will be described. The apparatus and conditions of the XRD measurement are not particularly limited as long as the apparatus is adjusted appropriately and calibration is performed using a standard sample. For example, the measurement can be performed with the apparatus and conditions as described below.
XRD apparatus: D8 ADVANCE produced by Bruker AXS
X-ray source: Cu
Output: 40 KV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: 1 second/step
Rotation of sample stage: 15 rpm

As a standard sample used for the adjustment and calibration, a standard sintered alumina plate SRM 1976 from National Institute of Standards and Technology (NIST) can be used, for example.

In the case where the measurement sample is a powder of a positive electrode active material or the like, the sample can be set by, for example, being placed on a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape and the position of the positive electrode active material layer of the positive electrode can be adjusted to the measurement plane required by the apparatus.

Characteristic X-rays may be monochromatized with the use of a filter or the like or may be monochromatized with XRD data analysis software after an XRD diffraction pattern is obtained. For example, a peak due to CuKα₂ radiation can be eliminated and only a peak due to CuKα₁ radiation can be extracted by using DEFFRAC.EVA (XRD data analysis software produced by Bruker Corporation). This software can also be used to eliminate the background, for example.

In addition, three kinds of samples were fabricated and three kinds of samples in which no calcium was added were fabricated for comparison, whereby six kinds of samples were prepared in total. For the three kinds of samples in which calcium was added, secondary particles in which adjustments were made such that the total of nickel, cobalt, and manganese was one and lithium was set to be at a molar ratio of 0.89, 0.95, and 1.01 were used. Furthermore, the secondary particles were fabricated such that calcium was set to 1 atm % with respect to the total of nickel, cobalt, manganese, and oxygen. For the three kinds of samples for comparison, secondary particles in which adjustments were made such that no calcium was added, the total of nickel, cobalt, manganese, and oxygen was one, and lithium was set to be at a molar ratio of 0.89, 0.95, and 1.01 were used. Each of the six kinds of samples was used to fabricate a half cell of a coin-type battery cell, and cycle tests were performed. Note that since FIG. 4 was referred to for the manufacturing flow, the positive electrode active material 200A was fabricated.

Acetylene black was used as a conductive material of each sample, mixing was performed to form a slurry, and the slurry was applied onto a current collector of aluminum.

After the slurry was applied onto the current collector, a solvent was volatilized. After that, pressure was applied at 210 kN/m. Note that the temperature of each of an upper roll and a lower roll of the roller press machine was 120° C. Through the above process, the positive electrode was obtained. The loading amount of the positive electrode was approximately 7 mg/cm². The loading amount of the positive electrode is the positive electrode active material weight per unit area.

Using the formed positive electrodes, CR2032 type coin-type battery cells (a diameter of 20 mm, a height of 3.2 mm) were fabricated.

A lithium metal was used for a counter electrode.

As an electrolyte of the samples, 1 mol/L of lithium hexafluorophosphate (LiPF₆) was used, and ethylene carbonate (EC) and diethyl carbonate (DEC) were mixed at EC:DEC=3:7 (volume ratio). The amount of vinylene carbonate (VC) added as an additive was set to 2 wt % with respect to the whole solvent. Although lithium hexafluorophosphate (LiPF₆) was used as the electrolyte, there is no particular limitation and one of lithium salts such as LiClO₄, LiAsF₆, LiBF₄, LiAlCl₄, LISCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LIN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

As a separator, 25-μm-thick polypropylene was used.

A positive electrode can and a negative electrode can that were formed of stainless steel (SUS) were used.

In the evaluation of cycle performance, the charging voltage was 4.5 V. The measurement temperature was 45° C. CCCV charging (0.5 C, 0.05 C cut) and CC discharging (0.5 C, 2.7 V cut) were performed, and a 10-minute pause time was taken before the next charging. In addition, a 10-minute pause time was also taken after the charging. Note that 1 C was 200 mA/g in this example. CCCV (constant current constant voltage) charging will be described. CCCV charging is a charging method in which CC charging is performed until the voltage reaches a predetermined voltage and then CV charging is performed until the amount of current flow becomes small, specifically, a termination current value. Charging was performed using the following charging method: CC (constant current) charging was performed at a charge rate of 0.5 C and then switched to CV (constant voltage) charging after reaching the upper limit voltage of 4.5 V. In addition, CC discharging will be described. CC discharging is a discharging method in which a constant current is made to flow from the secondary battery in the whole discharging period, and discharging is stopped when the secondary battery voltage reaches a predetermined voltage, in this example, 2.7 V.

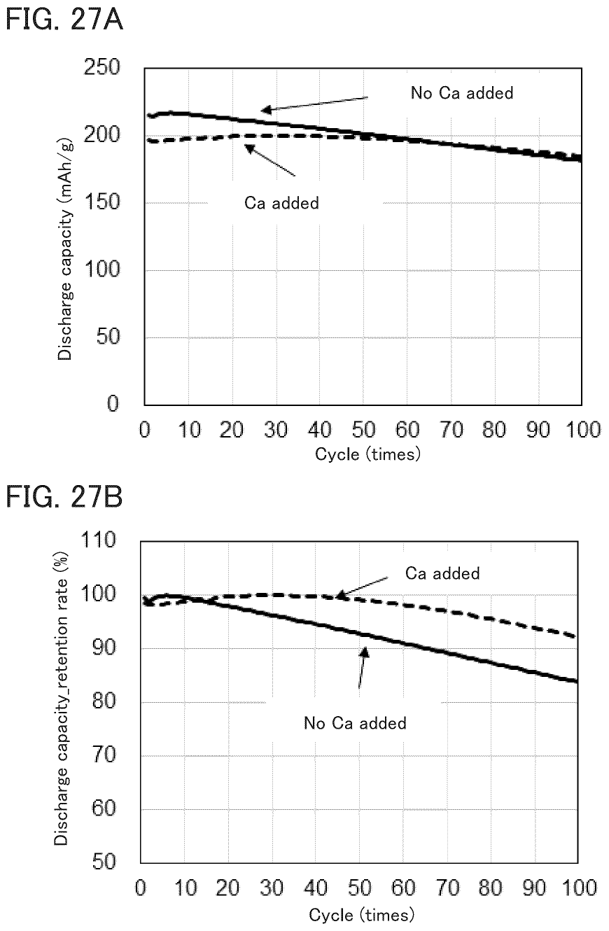

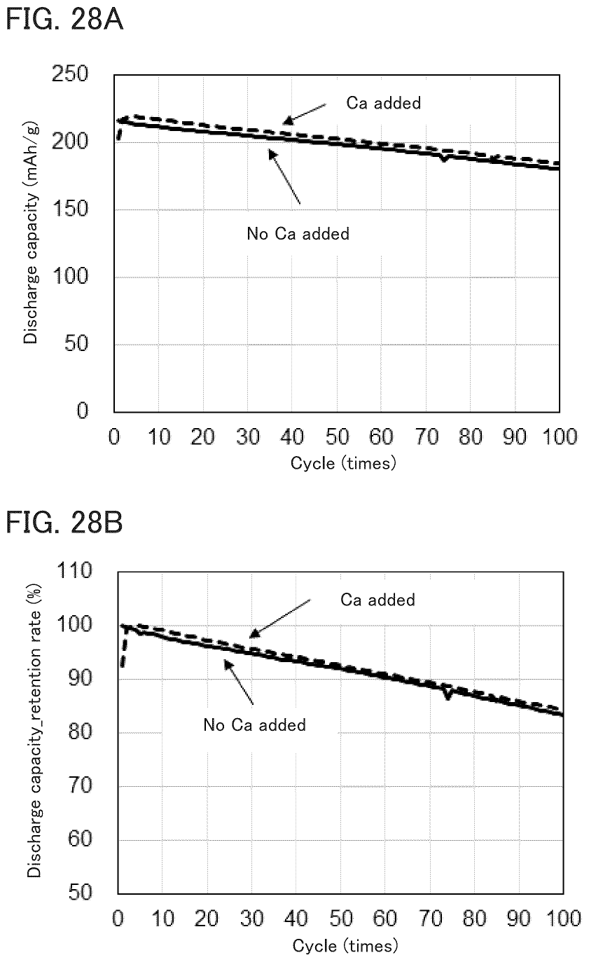

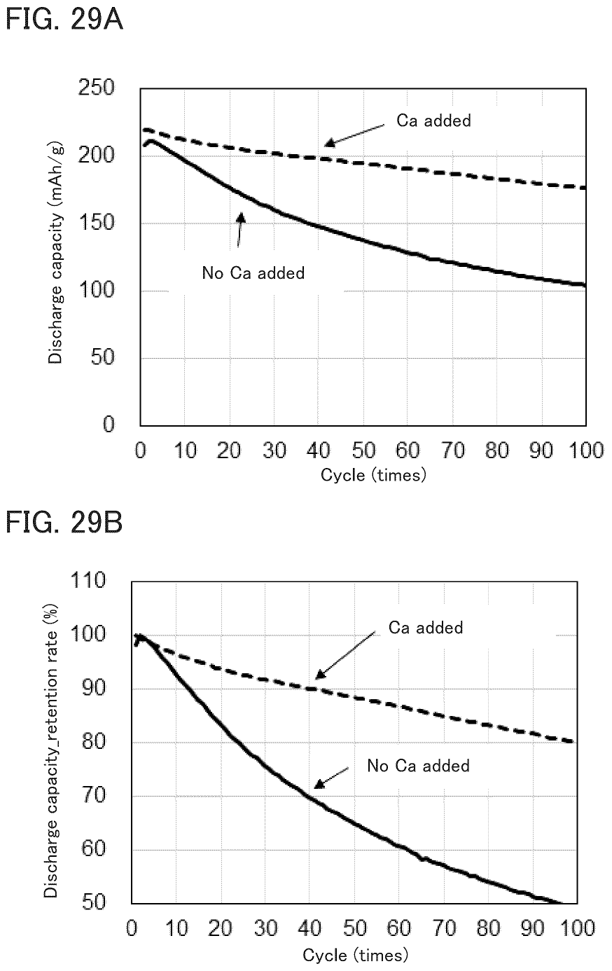

FIG. 27, FIG. 28, and FIG. 29 show evaluation results of each cycle performance. The vertical axis in FIG. 27A represents the discharge capacity, and the vertical axis in FIG. 27B represents the discharge capacity retention rate. Each of the positive electrode active materials 200A in FIG. 27A and FIG. 27B is NCM represented by Li_{0.89}Ni_{X}Co_{Y}Mn_{Z}O₂ (note that X+Y+Z=1, X=0.8, Y=0.1, and Z=0.1) and contains calcium in the coating film of the primary particle or the coating film of the secondary particle.

The vertical axis in FIG. 28A represents the discharge capacity, and the vertical axis in FIG. 28B represents the discharge capacity retention rate. Each of the positive electrode active materials 200A in FIG. 28A and FIG. 28B is NCM represented by Li_{0.95}Ni_{X}Co_{Y}Mn_{Z}O₂ (note that X+Y+Z=1, X=0.8, Y=0.1, and Z=0.1) and contains calcium in the coating film of the primary particle or the coating film of the secondary particle.

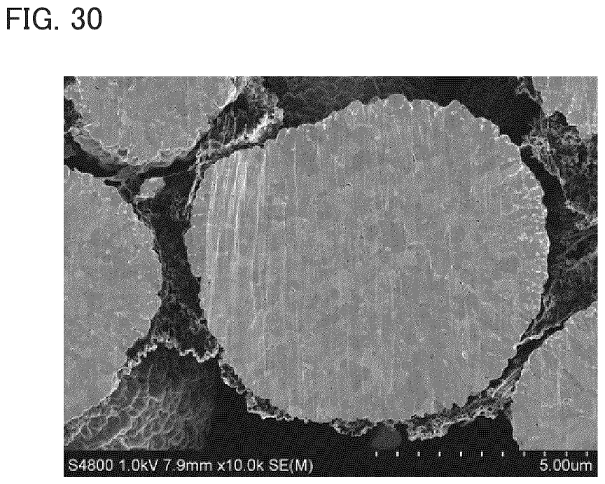

FIG. 30 shows a SEM observation image of a cross section of an electrode of the sample shown in FIG. 28A and FIG. 28B after 100 cycles of charge and discharge tests (4.5 V, 45° C.). In FIG. 30, a crack or the like is hardly observed, and it can be observed that a favorable state is maintained. Accordingly, it can be said that a secondary battery including a secondary particle that is also physically durable has been achieved.

The vertical axis in FIG. 29A represents the discharge capacity, and the vertical axis in FIG. 29B represents the discharge capacity retention rate. Each of the positive electrode active materials 200A in FIG. 29A and FIG. 29B is NCM represented by Li_{1.01}Ni_{X}Co_{Y}Mn_{Z}O₂ (note that X+Y+Z=1, X=0.8, Y=0.1, and Z=0.1) and contains calcium in the coating film of the primary particle or the coating film of the secondary particle.

The results in FIG. 26, FIG. 27, FIG. 28, and FIG. 29 show that there is a difference in cycle performance between the sample with calcium added and the sample with no calcium added even when no calcium was contained in a primary particle, which is a crystal, depending on the manufacturing flow:

These results confirmed that the cycle performance of the positive electrode active material 200A is improved by adding calcium between the primary particles.

Furthermore, even when calcium was contained in the positive electrode active material 200A, an initial discharge capacity exceeding 200 mAh/g can be obtained in the half cell.

### REFERENCE NUMERALS

170: coprecipitation synthesis apparatus, 171: reaction vessel, 172: stirrer, 173: stirrer motor, 175: tank, 176: tube, 177: pump, 180: tank, 181: tube, 182: pump, 186: tank, 187: tube, 188: pump, 190: control device, 192: aqueous solution, 200A: positive electrode active material, 200B: positive electrode active material, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 400: secondary battery, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 513: secondary battery, 514: terminal, 515: sealant, 517: antenna, 519: layer, 529: label, 531: secondary battery pack, 540: circuit board, 590a: circuit system, 590b: circuit system, 590: control circuit, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring. 622: wiring, 623: wiring, 624: conductor, 625: insulator, 626: wiring. 627: wiring, 628: conductive plate, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 750a: positive electrode, 750b: solid electrolyte layer, 750c: negative electrode, 751: electrode plate, 752: insulating tube, 753: electrode plate, 761: lower component, 762: upper component, 763: pressure screw; 764: butterfly nut, 765: O ring, 766: insulator, 770a: package component, 770b: package component, 770c: package component, 771: external electrode, 772: external electrode, 773a: electrode layer, 773b: electrode layer, 790: control device, 791: power storage device, 796: underfloor space, 799: building, 890: aqueous solution, 892: aqueous solution, 893: aqueous solution, 894: aqueous solution, 901: mixed solution, 904: mixture, 905: mixture, 906: mixture, 911a: terminal, 911b: terminal, 913: secondary battery, 930a: housing, 930b: housing, 930: housing, 931a: negative electrode active material layer, 931: negative electrode, 932a: positive electrode active material layer, 932: positive electrode, 933: separator, 950a: wound body, 950: wound body, 951: terminal, 952: terminal, 1300: rectangular secondary battery, 1301a: first battery, 1301b: first battery, 1302: battery controller, 1303: motor controller, 1304: motor, 1305: gear, 1306: DCDC circuit, 1307: electric power steering, 1308: heater, 1309: defogger, 1310: DCDC circuit, 1311: second battery, 1312: inverter, 1313: stereo, 1314: power window; 1315: lamps, 1316: tire, 1317: rear motor, 1320: control circuit portion, 1321: control circuit portion, 1322: control circuit, 1324: switch portion, 1413: fixing portion, 1414: fixing portion, 1415: battery pack, 1421: wiring, 1422: wiring, 1500: station, 1501: car, 1502: secondary battery, 1503: mechanism, 1504: partition plate, 1505: garage door, 2001: motor vehicle, 2002: transporter, 2003: transport vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charge equipment, 2610: solar panel, 2611: wiring, 2612: power storage device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 8600: motor scooter, 8601: side mirror, 8602: power storage device, 8603: indicator light, 8604: under-seat storage unit, 8700: electric bicycle, 8701: storage battery, 8702: power storage device, 8703: display portion, 8704: control circuit

1. A secondary battery comprising a positive electrode active material layer comprising a primary particle comprising lithium, nickel, cobalt, and manganese and a secondary particle formed by aggregation of a plurality of the primary particles,
wherein at least a portion of a surface of the primary particle comprises a coating film comprising lithium carbonate, and
wherein the coating film comprises calcium.

2. A secondary battery comprising a positive electrode active material layer comprising a primary particle comprising lithium, nickel, cobalt, and manganese and a secondary particle formed by aggregation of a plurality of the primary particles,
wherein at least a portion of a surface of the primary particle comprises a coating film comprising lithium carbonate, and
wherein a concentration of calcium contained in the primary particle is lower than a concentration of calcium contained in the coating film.

3. The secondary battery according to claim 1,
wherein calcium contained in the secondary particle is higher than or equal to 0.1 atm % and lower than or equal to 5 atm %.

4. The secondary battery according to claim 1,
wherein further at least a portion of a surface of the secondary particle comprises a coating film, and
wherein the coating film comprises calcium.

5. The secondary battery according to claim 1,
wherein nickel is contained in the secondary particle more than cobalt or manganese is.

6. The secondary battery according to claim 1,
wherein the secondary particle comprises a crystal having a layered structure.

7. A secondary battery comprising a positive electrode using the secondary particle according to claim 1.

8. The secondary battery according to claim 2,
wherein calcium contained in the secondary particle is higher than or equal to 0.1 atm % and lower than or equal to 5 atm %.

9. The secondary battery according to claim 2,
wherein at least a portion of a surface of the secondary particle comprises a coating film, and
wherein the coating film comprises calcium.

10. The secondary battery according to claim 2,
wherein nickel is contained in the secondary particle more than cobalt or manganese is.

11. The secondary battery according to claim 2,
wherein the secondary particle comprises a crystal having a layered structure.

12. A secondary battery comprising a positive electrode active material layer comprising a primary particle comprising lithium, nickel, cobalt, and manganese,
wherein at least a portion of a surface of the primary particle comprises a coating film comprising lithium, carbon, and calcium, and
wherein a concentration of calcium contained in the primary particle is lower than a concentration of calcium contained in the coating film.

13. The secondary battery according to claim 12,
wherein nickel is contained in the primary particle more than cobalt or manganese is.

14. The secondary battery according to claim 12,
wherein the primary particle comprises a crystal having a layered structure.
